(19) United States
(12) Patent Application Publication
(10) Pub. No.: US 2013/0218769 A1
(43) Pub. Date: Aug. 22, 2013

(54) Mobile Funding Method and System

(71) Applicants: Stacy Pourfallah, Oakland, CA (US); Thanigaivel Ashwin Raj, Foster City, CA (US)

(72) Inventors: Stacy Pourfallah, Oakland, CA (US); Thanigaivel Ashwin Raj, Foster City, CA (US)

(21) Appl. No.: 13/593,238

(22) Filed: Aug. 23, 2012

Related U.S. Application Data
(60) Provisional application No. 61/526,666, filed on Aug. 23, 2011.
(60) Provisional application No. 61/615,550, filed on Mar. 26, 2012.

(51) Int. Cl. G06Q 20/10

(52) U.S. Cl. CPC G06Q 20/10
USPC 705/44

(57) ABSTRACT

Systems and methods for mobile funding are provided. One such method comprises receiving a transaction request to transfer funds from a payor to a payee. The transaction request can include a payor device identifier, a payee device identifier and an amount. A payor account identifier associated with the payor device identifier, and a payee account identifier associated with the payee device identifier can each be determined. Additionally, a first service provider associated with the payor device can be determined based on the payor device identifier, and a second service provider associated with the payee device can be determined based on the payee device identifier. The transfer of funds from the first service provider to the second service provider can then be initiated using the payor account identifier and the payee account identifier. At least one of the first and second service providers is a mobile network operator.

### CROSS-REFERENCES TO RELATED APPLICATIONS

This application is related to U.S. Provisional Patent Application No. 61/526,666, filed on Aug. 23, 2011, titled “MOBILE FUNDING METHOD AND SYSTEM,” by Thanigaivel Ashwin Raj, and U.S. Provisional Patent Application No. 61/615,550, filed Mar. 26, 2012, titled “MOBILE PAYMENT MANAGEMENT,” by Thanigaivel Ashwin Raj, each of which are herein incorporated by reference in their entirety for all purposes.

### BACKGROUND

Many financial transactions are increasingly conducted over the Internet, telecommunications networks, or other communication network interfaces using mobile devices. In developed economies, conducting financial transactions using mobile devices enhances a consumer's financial experience and offers real-time control and convenience in managing the consumer's financial accounts. In developing economies, many consumers may not have established financial accounts. Therefore, using mobile devices may allow unbanked consumers to have simplified access to financial services and provide security in conducting daily financial transactions.

Particularly in developing markets lacking an established or standard financial technology infrastructure, it may be difficult to conduct secure transactions in the same manner as in typical transactions conducted in developed markets. Many of the consumers may be unbanked or under-banked, and therefore, may not have an associated bank account. However, unbanked or under-banked consumers may still use mobile devices, such as mobile phones. While developing economies may not have an established financial technology infrastructure, a telecommunications network or other network interface may exist, which can be used to conduct financial transactions. Additionally, even in markets with established infrastructure, remembering and managing multiple account numbers can be burdensome on consumers and lead to security lapses. Therefore a simplified method and system of securely conducting financial transactions using an existing infrastructure through mobile devices is needed.

Embodiments of the invention address this and other problems.

### BRIEF SUMMARY

Systems and methods for mobile funding are provided. One such method comprises receiving a transaction request to transfer funds from a payor to a payee. The transaction request can include a payor device identifier, a payee device identifier and an amount. A payor account identifier associated with the payor device identifier, and a payee account identifier associated with the payee device identifier can each be determined. Additionally, a first service provider associated with the payor device can be determined based on the payor device identifier, and a second service provider associated with the payee device can be determined based on the payee device identifier. The transfer of funds from the first service provider to the second service provider can then be initiated using the payor account identifier and the payee account identifier. At least one of the first and second service providers is a mobile network operator.

These and other embodiments of the invention are described in further detail below.

### BRIEF DESCRIPTION OF THE DRAWINGS

FIG. 1 shows a system according to embodiments of the invention.

FIG. 2 shows an exemplary mobile management service system in accordance with an embodiment of the invention.

FIG. 3 shows a block diagram of a mobile management service, in accordance with an embodiment of the invention.

FIG. 4 shows a method of depositing and/or withdrawing cash with an agent in a closed loop system, in accordance with an embodiment of the invention.

FIG. 5 shows a method of conducting a person to person (P2P) transfer in a closed loop system, in accordance with an embodiment of the invention.

FIG. 6 shows a method of depositing and/or withdrawing cash with an agent in an open loop system, in accordance with an embodiment of the invention.

FIG. 7 shows a consumer-initiated cash-out transaction with an agent in an open loop system, in accordance with an embodiment of the invention.

FIG. 8 shows a method of conducting a mobile to mobile P2P transfer in an open loop system, in accordance with an embodiment of the invention.

FIG. 9 shows method of conducting a mobile to card account P2P transfer in an open loop system, in accordance with an embodiment of the invention.

FIG. 10 shows a method of conducting a mobile initiated open loop transaction, in accordance with an embodiment of the invention.

FIG. 11 shows an example of device identifier recycling errors, in accordance with an embodiment of the invention.

FIG. 12 shows a method of reconciliation and settlement, in accordance with an embodiment of the invention.

FIG. 13 shows a method of consumer registration, in accordance with an embodiment of the invention.

FIG. 14 shows a block diagram of an exemplary system comprising a server computer in accordance with some embodiments.

FIG. 15 shows an exemplary computer apparatus in accordance with some embodiments.

FIG. 16 shows an exemplary mobile device in accordance with some embodiments provided herein.

### DETAILED DESCRIPTION

The following disclosure may provide exemplary systems, devices, and methods for conducting a financial transaction and related activities. Although reference, may be made to such financial transactions in the examples provided below, embodiments are not so limited. That is, the systems, methods, and apparatuses described herein may be utilized for any suitable purpose.

Before discussing specific embodiments and examples, some descriptions of terms used herein are provided below.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment, but other elements may be added and still form a construct within the scope of a claim. In contrast, the transitional phrase “consisting of” excludes any element, step, or ingredient not specified in a claim. This is consistent with the use of the term throughout the specification.

As used herein, an “electronic wallet” or “digital wallet” can store user profile information, payment information, bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

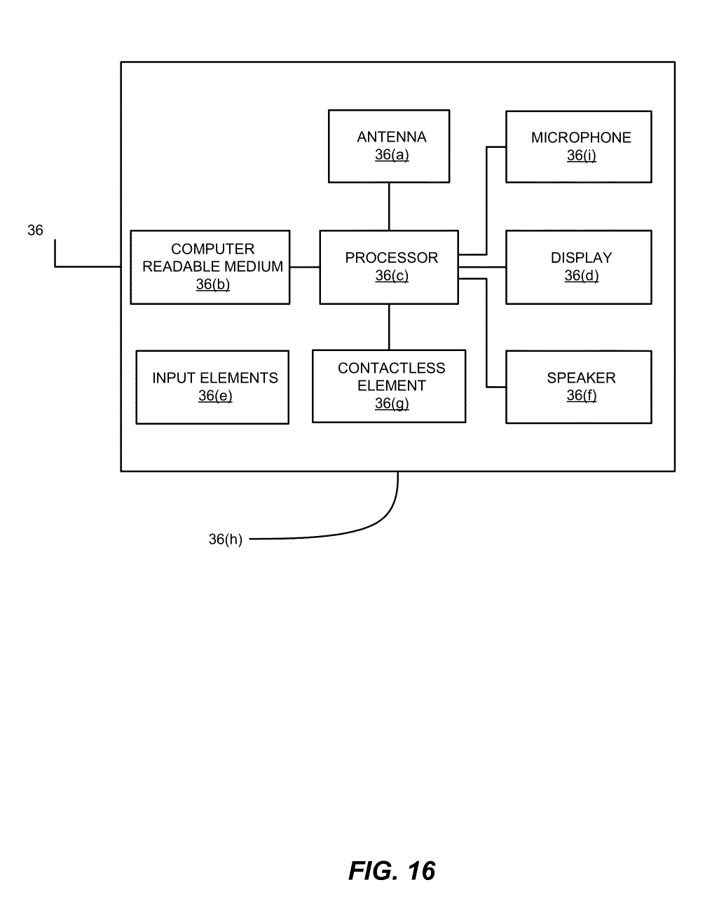

As used herein, a “mobile device,” “consumer device,” “agent device” or “device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below with reference to FIG. 16.

As used herein, an “online purchase” can be the purchase of a digital or physical item or service via a network, such as the Internet.

As used herein, a “payment account” (which may be associated with one or more payment devices) may refer to any suitable payment account including a credit card account, a checking account, a prepaid account, or a mobile money account.

As used herein, a “payment device” may refer to any device that may be used to conduct a financial transaction, such as to provide payment information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of payment devices include cellular phones, personal digital assistants (PDAs), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode. An exemplary payment device is described below with reference to FIG. 17.

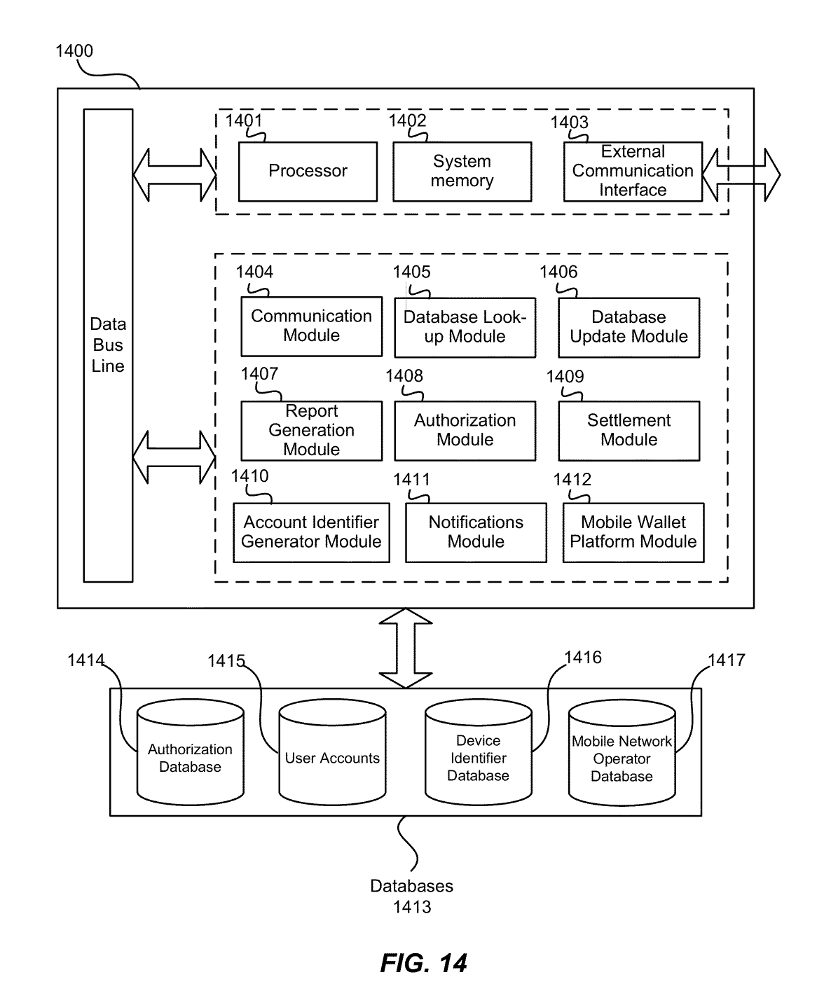

As used herein, a “server computer” is typically a powerful computer or cluster of computers. For example, the server computer can be a large mainframe, a minicomputer cluster, or a group of servers functioning as a unit. In one example, the server computer may be a database server coupled to a Web server. An example of a server computer is described in FIG. 14.

As used herein, a “service provider” can broadly refer to the provider of a mobile money service and/or a mobile network service. In accordance with an embodiment, a Mobile Money Operator (MMO) refers to the entity that provides a mobile money service in a specific country (e.g., financial institutions, etc.) and a Mobile Network Operator (MNO) refers to the entity which provides mobile network service, such as a cellular telephone service provider. In accordance with an embodiment, a MNO can be an MMO and either can be referred to as a service provider.

As used herein, a Mobile Money Platform (MMP) refers to the platform providing the technology and/or operations for the mobile money service.

As used herein, an “agent” is typically an end user with a commercial mobile account and a business relationship with a service provider/mobile money operator (MMO). Agents can be utilized by consumers to open an account with a mobile money operator, transfer money to other consumers, pay bills, and make deposits and withdrawals as described herein. In accordance with an embodiment, a partner bank with which the MMO maintains a collateral account can act as an agent for the MMO. The partner bank can interface with the MMO over a mobile network or other internet connection, such as through a web interface. In accordance with an embodiment, an automated teller machine (ATM) can also serve as an agent for the MMO.

As used herein, a “consumer” is typically an end user with a mobile money account with a mobile money operator (MMO). Consumers can typically access and manage their mobile money accounts using a consumer device, such as a mobile phone which is serviced by a service provider/mobile network operator. Consumers can perform a plurality of transactions using their consumer device and visit agent's to perform transactions which need to be transacted in person, such as deposits and withdrawals.

A consumer (payor) may wish to transfer funds to another consumer (payee), however either the payor, payee, or both may not have payment cards (e.g., credit or debit cards), and thus may not have pre-existing accounts with an issuer, such as a bank. Therefore embodiments of the invention provide a system and method for the payor and payee to conduct transactions with each other using an identifier other than an account identifier. For example, the payor and payee may have their respective devices (e.g., mobile phone) and may provide their device identifiers (e.g., mobile phone number) to a mobile money operator (MMO) which can connect to a payment processing network (e.g., VisaNet) in a transaction request to transfer funds from the payor to the payee.

In embodiments of the invention, a number of data conversion steps may take place to facilitate the integration of the components. For example, in embodiments of the invention, communication between a consumer device, such as a mobile phone, and a mobile money platform may be in the form of a standard communication such as an SMS message or e-mail message. Communication between the mobile money platform (MMP) and a mobile money gateway (also referred to herein as a central connection processor (CCP)) may be with a markup language such as XML. Further, communication between the mobile money gateway and a payment processing network may take place using a payment card-type transaction message such as an ISO 8583 type message. Within ISO 8583, a bitmap is a field or subfield within a message which indicates which other data elements or data element subfields may be present elsewhere in a message. As processing proceeds from component to component, transaction information can be extracted from the received message and reformatted into a message for the next component. Similar extraction and reformatting may also be performed, in reverse, for response messages which are sent from component to component.

For example, a consumer can initiate a person to person (P2P) transaction by sending an SMS from his mobile phone to his MMP. The SMS can include, e.g., a mobile phone number of a recipient, and an amount to transfer to the recipient. The MMP may extract the recipient's mobile phone number and the amount from the SMS request, as well as capture the consumer's mobile phone number. The MMP can then format the transaction request into an XML message using the extracted and captured information from the consumer's SMS and pass this XML message to the mobile gateway. The mobile gateway can then similarly extract and reformat data from this message into a new message for the next component.

To initiate a transaction to transfer funds from a payor to a payee, the payor may provide his device identifier and the payee's device identifier (e.g., device identifiers can comprise mobile phone numbers) to a payment processing network (e.g., VisaNet). The payor device identifier and payee device identifier may be included in a transaction request to the payment processing network. The devices of the payor and payee (e.g., mobile phone) may have associated device identifiers (e.g., mobile phone numbers) and may be issued and operated by a mobile network operator (e.g., AT&T, Verizon). To possess the mobile device, the payor or payee may have an account with the mobile network operator to receive network communication services to the mobile device via a telecommunications network, the Internet, or other suitable network interface.

The payment processing network may determine a payor account identifier associated with the payor device identifier and a payee account identifier associated with the payee device identifier. The account identifiers may be determined in many ways, including generating, converting, or mapping. The account identifiers may be generated randomly or generated using an algorithm. In other embodiments, account identifiers may be mapped to device identifiers and stored in a central registry (e.g., a routing directory) which can be used to identify a user's account identifier based on their device identifier. The payor and the payee may not be aware of the determined account identifiers during the transaction.

Based on the device identifiers of the payor and payee, the payment processing network determines a service provider (e.g., mobile network operator) of the payor device and the payee device. Each service provider acts as an issuer bank to the devices which subscribe to the service providers services. As described herein, the service provider can be a mobile network operator (MNO) also referred to as an issuing MNO. The payment processing network may search an MNO database and a device identifier database to determine the issuing MNO associated with a device identifier.

When the mobile network operator of the payor device and the mobile network operator of the payee device have been identified, the payment processing network electronically communicates with the mobile network operator of the payor device (i.e., payor issuer) and the mobile network operator of the payee device (i.e., payee issuer). Using the payor account identifier and the payee account identifier, the payment processing network facilitates the electronic transfer of funds from the payor MNO to the payee MNO. The payment processing network can then electronically transmit notifications to the payor device and the payee device that the transaction to transfer funds is complete.

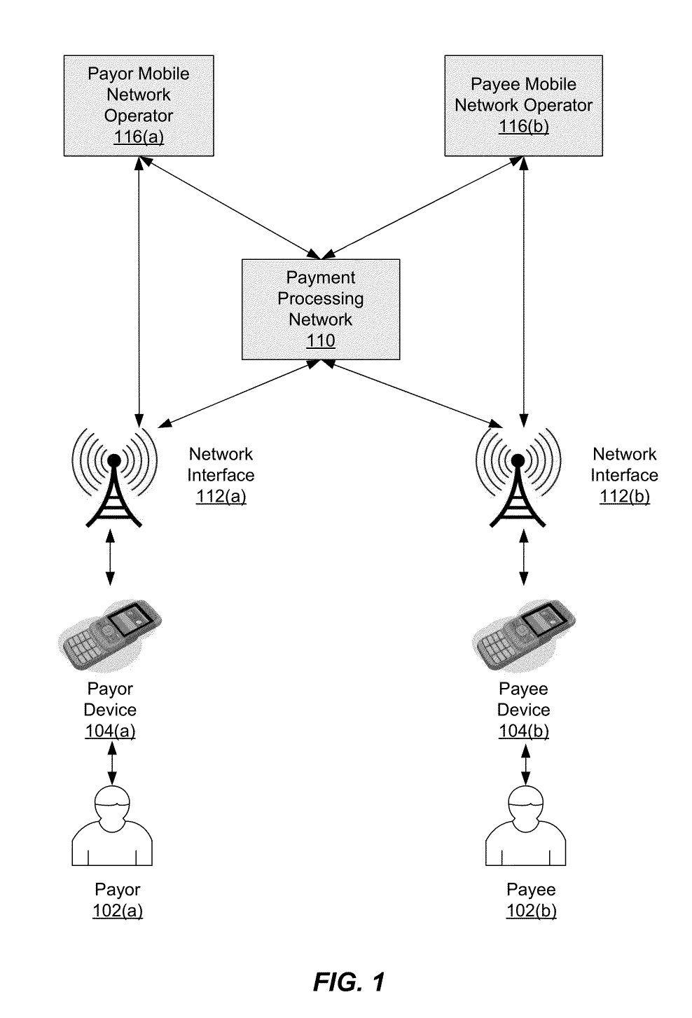

FIG. 1 shows a system according to embodiments of the invention. A payor 102(a), in possession of a payor device 104(a), can conduct a transaction with payee 102(b), in possession of a payee device 104(b). The payor device 104(a) may be issued by, and communicate through a network interface 112(a) operated by a payor mobile network operators 116(a). The payee device 104(a) may be issued by, and communicate through a network interface 112(b) operated by, a payee mobile network operator 116(b). The payor and payee mobile network operators can be the same or different mobile network operators, e.g., transactions can be conducted between subscribers to the same mobile network and between subscribers of different mobile networks. In accordance with an embodiment either the payor or the payee may access the MMO through an internet connection other than the mobile network, such as through a computer connected to the internet by a wired connection.

The payor device 104(a) may electronically communicate with the payment processing network 110 via network interface 112(a) to initiate the transaction. The transaction may be initiated by the payor 102(a) with a transaction query, including a payor device identifier associated with the payor device 104(a) and a payee device identifier associated with the payee device 104(b).

The payment processing network 110 determines a generated payor account identifier for the payor device 104(a) and a generated payee account identifier for the payee device 104(b). Additionally, the payment processing network 110 determines the payor mobile network operator 116(a) associated with the payor device 104(a), and the payee mobile network operator 116(b) associated with the payee device 104(b).

Using the generated payor account identifier and the generated payee account identifier, and electronically communicating with both the payor mobile network operator 116(a) and the payee mobile network operator 116(b), the payment processing network 110 facilitates the electronic transfer of funds from the payor mobile network operator 116(a) to the payee mobile network operator 116(b).

The payment processing network 110 then communicates with the payee device 104(b) via a network interface 112(b) operated by the payee mobile network operator 116(b) to notify the payee 102(b) that the transfer of funds is complete. A notification to the payor device 104(a) may also be electronically transmitted by the payment processing network 110 via the network interface 112(a).

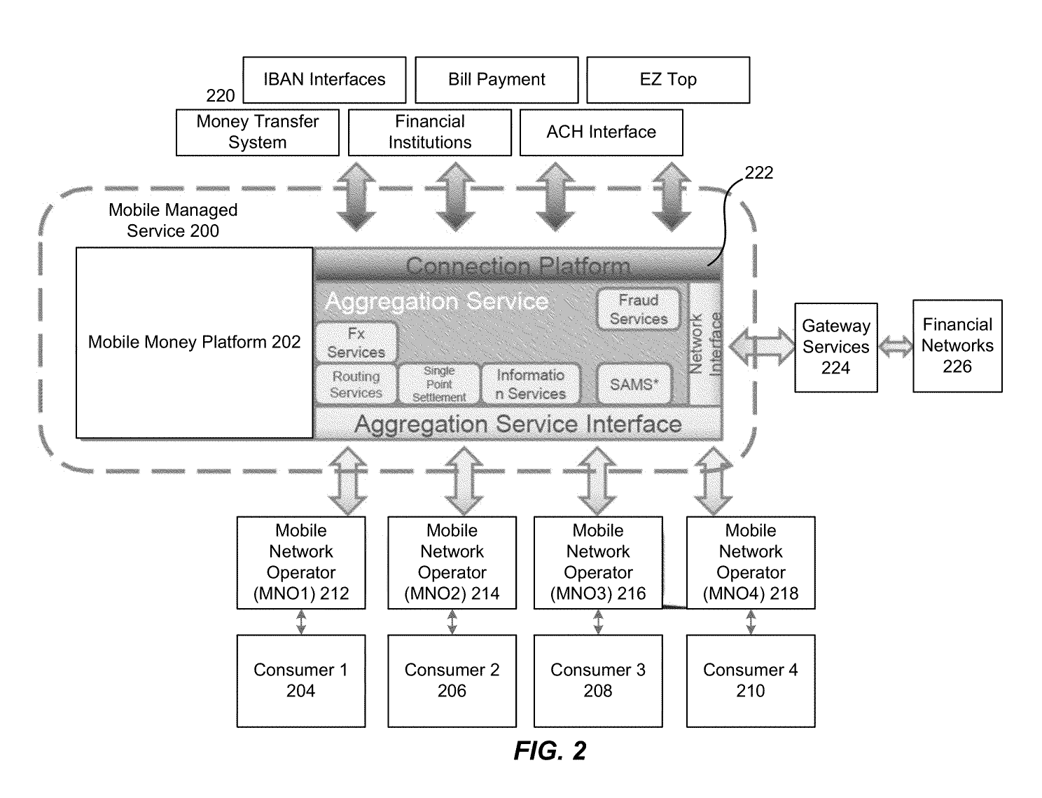

FIG. 2 shows an exemplary mobile management service system in accordance with an embodiment of the invention. As shown in FIG. 2, the mobile managed service (MMS) system 200 can include a mobile money platform (MMP) 202 and a central connection platform 204. The MMS can be provided by the MMO to serve as an interface between the mobile networks provided by the MNOs and the payment processing networks. The central connection platform can provide a plurality of value added services to both closed and open loop transactions to consumers 206-212, connected to the mobile managed service 200 through mobile network operators (MNO) 214-220, and agents/services 222 (e.g., ACH interfaces, financial institutions, and western union). The central connection platform 204 can connect using gateway services 224 to one or more payment processing networks 226, such as Visa, MasterCard, or American Express.

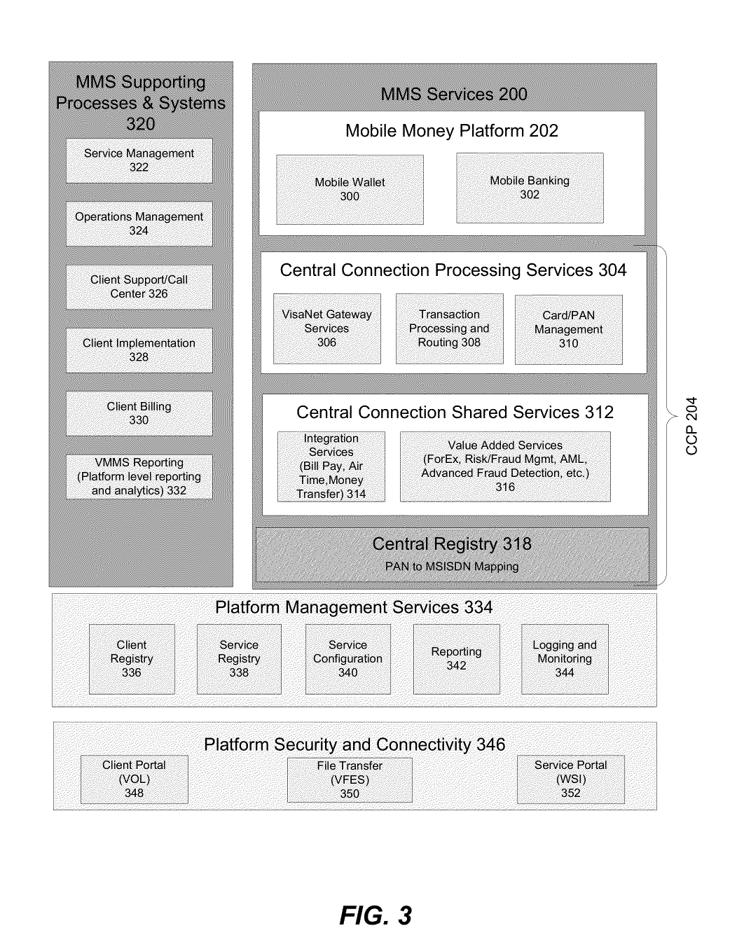

In accordance with an embodiment, MMS 200 can provide two factor authentication in which transactions are authenticated by the consumer and authentication is performed using the consumer's device, such as a mobile phone. Consumer communications can be provided electronically through the consumer's device which can be linked to one or more accounts through central connection platform 204. The MMS can support open and closed loop transactions, for example person to person transactions between subscribers to the same MNO, or across MNOs, transactions with merchants, and transactions with agents of different MNOs. This way, the MMS can provide a plurality of banking services and convenience without requiring branch locations or the consumers to have traditional bank accounts. Additional details of the MMS are provided below with respect to FIG. 3.

FIG. 3 shows a block diagram of a mobile management service, in accordance with an embodiment of the invention. MMS Services 200 can include a plurality of distinct functional components, which can be provided in bundles of services which are tailored to a particular deployment environment (e.g., based on the networks and other infrastructure available in a particular deployment environment). The Mobile Money Platform 202 can include a mobile wallet service 300 and a mobile banking service 302. The mobile wallet service 300 can provide a full feature implementation of a Mobile Wallet, any suitable mobile wallet can be utilized. The mobile wallet can facilitate integration with financial institutions for control accounts and net settlement positions. The mobile banking service 302 provides a mobile interface and processing capabilities. Each MMO/MNO can maintain consumer/agent account details and balances and utilize the mobile banking service to pass transaction data from the mobile devices to the MMO/MNO/bank and vice versa using APIs. The mobile wallet 300 and mobile banking service 302 can each provide several feature sets that are configurable within the mobile money platform based on consumer/agent needs. These feature sets can include, but are not limited to, Mobile Payments, Mobile Account Transfers, Mobile Remittances, Mobile Notifications, and Account Inquiry. In accordance with an embodiment, each client can utilize their own MMP which is configured to communicate with CCP 204 or can utilize a native MMP provided by the MMS.

Central Connection Platform (CCP) 204 can include Central Connection Processing Services 304, which can provide gateway services 306, transaction processing and routing services 308 and card/PAN management services 310. In accordance with an embodiment, each of these services can also be provided separately by an MMP, or utilized selectively by an MMP in combination with one or more similar features provided by that MMP. CCP 204 can also include Central Connection Shared Services 312. These are services that can be implemented to support mobile money platforms. For example, integration services 314 can provide bill pay, air time management and money transfer services to consumers through MMP 202. Additionally, value added services 316 can provide foreign exchange (FX) and risk/fraud services. For example, FX services enable the MMS to facilitate domestic and international transactions. FX services can monitor transactions and determine if there is a country or currency difference between parties to a transaction and ensure that transactions are structured appropriately. The FX services can also provide current exchange rates for transactions.

CCP 204 can further include a Central Registry (or routing directory) 318. The central registry enables cross platform money transfers using device identifiers (e.g., a mobile phone's MSISDN). The central registry 318 can store mappings of device identifiers to personal account numbers (PANs) and can be used to look-up PANs corresponding to device identifiers to conduct transactions, such as person to person (P2P) money transfers. The central registry 318 can also store a lock status for each account, which can be used to determine whether funds can be transferred from (debited) an account. Additionally, where more than one account is associated with a device identifier, the central registry can include a default account flag which indicates which of the accounts associated with a device identifier should be selected in the absence of a specific account number being identified in a transaction.

The CCPS 304 can include a gateway services module 306 used to connect to payment processing networks, such as VisaNet. The gateway services can support authorization, routing, file staging, and delivery services, and provide secure connectivity to the payment processing networks. In accordance with an embodiment, the gateway services can evaluate incoming messages and determine an appropriate MMP to which to route the messages to deliver the message content. The gateway services can also capture and log message responses from each MMP for audit purposes. The gateway services can route each response from the MMP to the request originator, and provide a real time connectivity interface with the consumer's or agent's MMP to request authorization and receive approval or decline confirmation. The gateway services can distinguish between different types of transactions. This determination can be made based on the product ID and transaction type field of each request.

The Card/PAN Management module 310 can provide a plurality of card and PAN management services for each MNO. For example, an MNO can request non-personalized cards. These cards are not embossed with a particular consumer's name, but can be distributed to consumers through the MNO's agents and linked to consumer devices. When a request is received, the CCPS can generate a batch of PANs based on the MNO's BIN and transmit an order to a card vendor. The card vendor can create and send the cards to the MNO or each of the MNO's agents who can then sell and/or distribute the cards to consumers. Additionally, the card/pan management module 310 can manage, blacklist/hotlist lost and stolen cards based on notifications received from the consumers. For example, an option can be presented on the consumer's device to indicate that a card has been lost or stolen. The card/PAN management module can then identify the device identifier-PAN mapping in the Central Registry and disable the static PAN associated with the consumer's account. The CCPS 304 would then issue a new virtual PAN to the consumer. Additionally, the consumer can receive a confirmation that their physical plastic PAN has been disabled and that they mobile account still works with the newly issued virtual PAN.

In accordance with an embodiment, each MMP can have one consumer BIN and one commercial BIN. The CCPS 304, through card/PAN management module 310 can assign different account ranges, one for static PAN generation and the other for one time use PAN generation (for both consumer and commercial BINs). The one time use account range can be used for generating PANs that will be used for cash claim and cardless (ecommerce) transactions. The CCPS can have a configurable parameter which indicates the expiration time for the different types of PANs. The consumer BIN can be used to issue accounts to agents of the MNO.

The Central Registry 318 can store each BIN and identify it as a consumer or agent BIN for each MNO. The CCPS 304 can also have configuration capabilities to define the account ranges and expiration date for non-personalized cards outside of the account ranges for system generated static PAN and single use PAN within the same BIN. Additionally, the CCPS 304 can provide a configuration option to distinguish between different types of PAN generation approaches. The CCPS 304 can also generate a onetime use PAN, including 16 digit account number, expiration date and CVV2 when a request is received from the MMP. The CCPS can also provide ability to configure the account activation period for onetime use PAN and static unlocked PAN. This activation period can be defined in hours and represents the time a PAN will be available for use from the time the initial creation.

In accordance with an embodiment, only a single onetime use PAN can be active at any point in time for a particular account. If a request is received for a new onetime use PAN before an existing onetime use PAN has been used or expired the system can automatically disable the previously generated onetime use PAN and generate a new PAN based on the current request. If a onetime use PAN is not used, the number can be returned to the pool and be available for use in future onetime PAN requests. Additionally, the CCPS 304 can maintain a record of the one-time PAN to static PAN activity and can produce a historical activity log, using logging and monitoring service 344, when the one-time PANs are recycled for audit purposes.

Although in accordance with an embodiment only one static PAN can exist at a time for a consumer account, agent accounts can have multiple static PANs assigned to allow for instances when an agent is also using the service as a consumer (two source funds accounts with different PANs). The agent-multiple PANs can be associated with a configurable setting which can determine whether and how many PANs can be created. By default, this setting can be set to no.

As described above, the CCPS 304 can support different approaches to the creation of PANs. For example, the CCPS 304 can provide the ability to generate a static PAN including a 16 digit account number, expiration date, CVV2 and associated track data for generating a physical card. The CCPS 304 can also have a random number generation functionality for generating static PAN as well as onetime use PAN. When a new consumer or agent account is created within a given MNO, the system can automatically generate and assign a static PAN to the account. In accordance with an embodiment, PAN generation can be random (e.g., Mod 10 algorithm) using the BIN and a defined account range start and end point. The CCPS 304 can also provide the ability to accept a request (originating at the MMP level) to generate one-time use PAN including 16 digit account number, expiration date and CVV2, and include an optional amount limit (validation of which can be the responsibility of the MMP). This information can be stored in the Central Registry 318. When created, static PANs can be in a “locked” state where it can receive inbound money transfers (credits) but cannot be used for a transaction that removes funds from an account (debits). Account can then remain in the “locked” state until a request is received from the account owner to unlock the account for usage.

Similarly, the CCPS 304 can provide the ability to generate a PAN based on a defined formula. For example, each PAN can be generated based on BIN+device identifier+1 digit sequence number+check digit. In accordance with an embodiment, position 1-6 can be BIN, positions 7-16 can be the device identifier (padded with zeros if less than 10 digits, does not include country code), position 17 can be a single digit account sequence number starting with 1, and position 18 is a check digit. Each account can have a single derived PAN using this formula. As a new account is created for an existing device identifier the next sequence will be used for identifying the account within the transaction.

The CCPS 304 can also provide the ability to store mapping of each PAN to a service provider (MMO/MNO) and a device identifier. Currency of each PAN can be specified. CCPS can also provide a service/API to create and update the mapping of device identifiers to PANs under each MMO/MMP. Each service request can include service provider ID, device identifier, PAN, optionally a Consumer Defined Account Name, Expiration date, and Currency, MMP account identifier, and Agent ID. In accordance with an embodiment, the CCPS can also provide the capability to deactivate/remove a mapping from the repository in the event that an account is closed. Each MMP can send a periodic file (weekly/monthly) with a list of deactivated device identifiers accounts to CCPS 304.

MMS supporting processes and systems 320 provide a plurality of services 322-332. These services facilitate integration with clients (e.g., MMOs/MNOs) to provide MMS services to consumers. Additionally, each service provider can select bundles of MMS services to be provided to consumers, using these supporting processes and systems. For example, service management 322 can include configuration parameters (e.g., account activation settings, velocity limits, etc.), performance requirements, and bulk file processing settings. Operations management 324 can provide CCP infrastructure monitoring and service monitoring. A plurality of support functions can be provided by client support/call center 326. Client implementation 328 can include a participation agreement for the CCP and program registration. Client billing 330 can provide an interface to a member billing system, such as Visa's global member billing system (GMBS), which can provide access to the client's billing line and rate setup.

In accordance with an embodiment, the Platform Management Services 334 can include a client registry 336 and a service registry 338. The client registry can track and manage clients of the mobile managed service (MMS). In this context, a client can refer to a service provider, such as a MNO, which utilizes the MMS to provide mobile money services to consumers, or to an MMP utilized by the service provides to provide access to the CCPS. The client registry can enable new clients to be added to the system. When a new client is added to the system, a client ID is generated for the new client. The business name of the client, and a display name (such as an abbreviated business name) can also be stored. A client business ID can also be assigned to the new client. A client type, such as an MNO, financial institution, mobile processor, etc., can also be stored, along with a country code and currency code indicating where the client is located and their operating currency. Additional IDs can be assigned as needed depending on the organizational needs of the MMS.

The client registry can also include an audit function. Whenever changes are made to the registry, audit information can be recorded. For example, for each change made, the system can record Created by, Created date, Modified by, and Modified date information for each change. In accordance with an embodiment, a plurality of client types can be used by the client registry. these can include MNO (Mobile Network Operator), Financial Institution, such as an Issuer or Acquirer supporting the MMO/MNO, Processor, which refers to a processor supporting mobile money transactions for the financial institutions, and Merchant/Retailer. Client contact information can also be stored for each client. For example, this information can include names, titles, phone numbers and email addresses of personnel at each client. If clients are no longer affiliated with the MMS, they can be deleted by setting a status as inactive. Other client information, aside from the client ID can be updated as needed.

Additionally, the client registry can manage the Mobile Money Platform (MMP) used by the clients stored therein. This management can include accessing and updating configuration information utilized by Mobile Money Processing Services (MMPS)/Gateway Services. Each client can be associated with a different MMP, and the client registry can store MMP-specific information for each client such as a Mobile Money Platform ID, which is a unique identifier to refer to each client's MMP, a Mobile Money Platform Name and description. The information can also include access and communication information such as security parameters, IP addresses, batch interfaces, etc.

In accordance with an embodiment, the Service Registry 338 can manage and configure services provided by the MMS, as well as enroll clients in different services or bundles of services. The service registry can maintain a configuration of dependent services that need to be added during client enrollment based on the services selected by the client. As part of the MMS a client can choose a full suite of services or select services individually, but any dependent services based on a selected service component can be automatically selected for enrollment. As part of the service definition, the system shall have the capability to define and maintain these relationships and dependencies between the services offered.

A Service Configuration module 340 can capture the configuration attributes for each service offered by the MMS and the Mobile Money Processing Services that are to be persisted to manage the operations and running of each of the service. Additionally, Client Service Configurations can be recorded and maintained for each service the client has enrolled in. Further, the service registry can track the services a client has enrolled in as service subscriptions. Each service offered by the MMS can be subscribed to by each client and the system can enable provisioning and operation of those services for each client based on client enrollment to those services. Each of these service components can validate the subscription of status of each client for those services for transaction processing and other functions. Reporting service 342 can provide settlement and reconciliation reporting, at the MMP level. The reporting service can also generate reports that include clearing positions at the MMP level for MMS transactions. In accordance with an embodiment, for all inbound and outbound settlement requests the system can capture the details of the settlement including the settlement entities, the specific PAN, transaction type, amount and currency.

Platform Security and Connectivity services 346 provide connection, authentication, and security services to subscribers and users of the MMS. Users can connect to the MMS through this service layer and be authenticated prior to accessing other services provided by the MMS. This layer provides access and security for the services platform and is in addition to any security functions provided by each MMP. This layer can include a client portal 348 and a service portal 352 through which each client of the MMS (e.g., MMOs and MNOs) can connect to and utilize the services of the MMS. Secure file transfer between clients, the MMS, services and consumers can be effected through a file transfer module 350 on this layer.

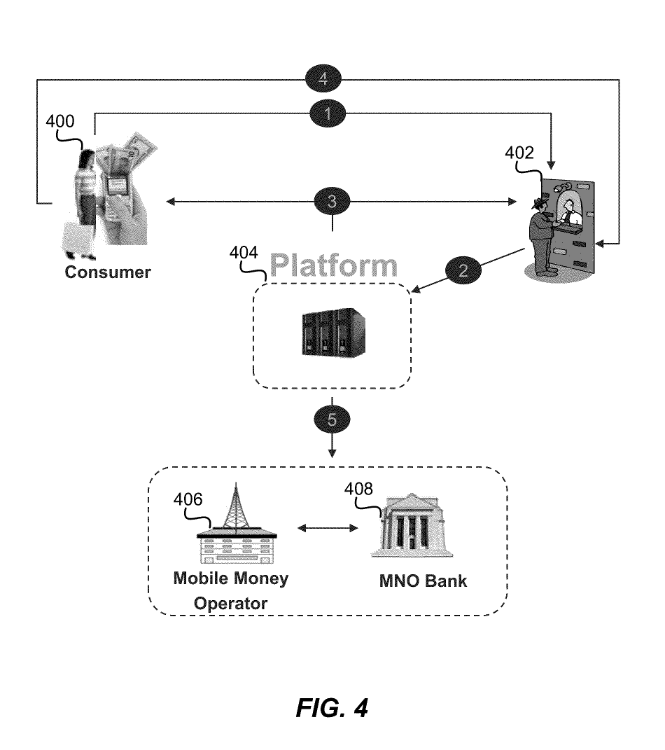

FIG. 4 shows a method of depositing and/or withdrawing cash with an agent in a closed loop system, in accordance with an embodiment of the invention. As shown in FIG. 4, at step 1 a consumer 400 can visit an agent 402 to perform a cash-in (deposit) and/or a cash-out (withdrawal) transaction. In the developing world, bank branches and ATMs can be uncommon, making common banking transactions more difficult. As such, agents (i.e., an end user with a commercial mobile account and a business relationship with a service provider) can be used to provide many services one would expect to receive by visiting a branch, such as making deposits and withdrawals, opening and closing accounts, etc. At step 2, the agent 402 can authenticate and initiate the cash-in or cash-out transaction with a mobile money platform (MMP) 404, using the agent's device, such as a mobile phone. The agent can input the consumer's device identifier and an amount of the transaction into the agent's device. The consumer 400 can then be prompted to enter a passcode associated with their account using the agent's device, or in response to an authentication message sent from the MMP 404 to the consumer's device. At step 3, the MMP can verify the consumer's account details and passcode, credit (for cash-in) or debit (for cash-out) the consumer's account with the appropriate amount of funds, debit (for cash-in) or credit (for cash-out) the agent's account of the same amount of funds, and provide the consumer 400 and agent 402 with confirmation that the transaction is complete. At step 4, the agent receives cash from (if cash-in) or provides cash to (if cash-out) the consumer equal to the amount deposited or withdrawn. At step 5, settlement of the transaction is handled by the mobile money operator (MMO) 406 and/or mobile network operator (MNO) 408. Since this is a closed loop transaction, both the payor and payee belong to the same MNO.

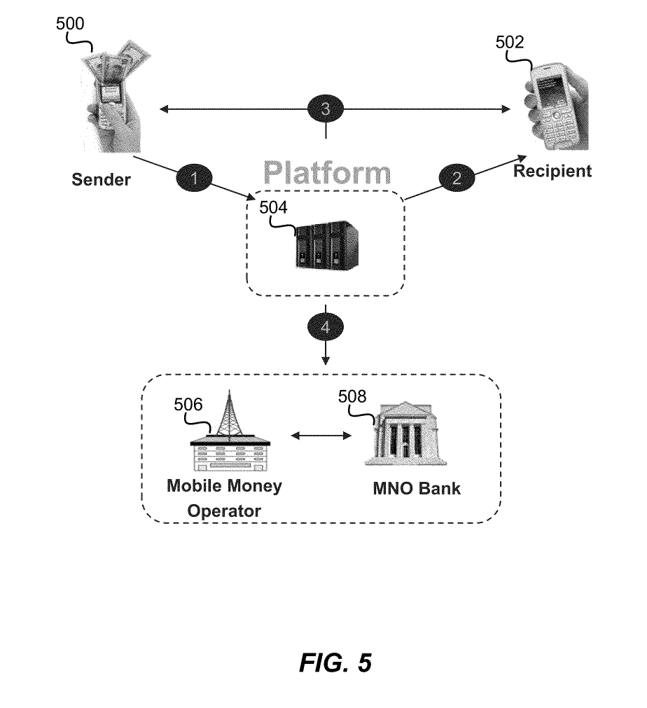

FIG. 5 shows a method of conducting a person to person (P2P) transfer in a closed loop system, in accordance with an embodiment of the invention. At step 1, a payor, using payor device 500, can initiate a P2P transaction with a recipient, who possesses a recipient device 502, through a mobile money platform (MMP) 504. To initiate the transaction using the MMP, the payor can provide a passcode which the MMP can use to authenticate the payor's identity. The transaction request can include recipient details such as account number, amount, name, and a memo. At step 2, the MMP 504 can then debit the payor's account and credit the recipient's account accordingly. At step 3, the MMP 504 can send a confirmation of the transaction to both the payor device 500 and recipient device 502 such as through an SMS message, smartphone application notification, or other mobile device notification. At step 4, the settlement position for the transaction is provided to the MMO 506 and or MNO 508 associated with the payor and recipient. Since this is a closed loop transaction, both the payor and payee belong to the same MNO.

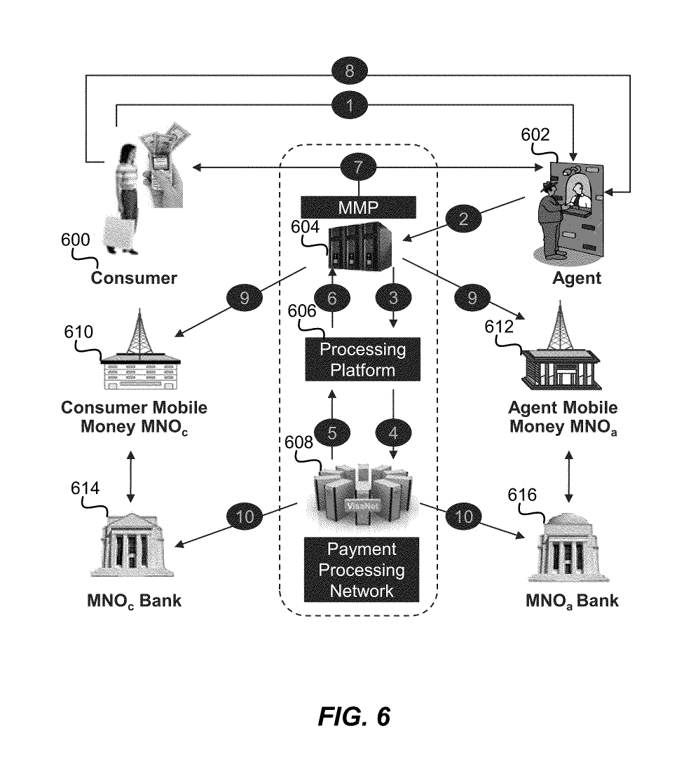

FIG. 6 shows a method of depositing and/or withdrawing cash with an agent in an open loop system, in accordance with an embodiment of the invention. As shown in FIG. 6, at step 1 a consumer 600 can go to an agent 602 to perform a cash-in or cash-out transaction. Since this is an example of an open loop transaction, the agent can be an agent of the consumer's MMO, or an agent of a different MMO. At step 2, the agent can authenticate and initiate the requested transaction with the agent's MMP 604 using the consumer's device identifier (e.g., a MSISDN associated with the consumer's mobile phone). To initiate the request, the agent can send an SMS from the agent's device to the agent's MMP, an email request, or similar electronic request. In accordance with an embodiment, the consumer and the agent can each be associated with a different MMP, for example if the agent and consumer are members of different MMOs. Processing platform 606 can facilitate transactions across MMPs (and therefore across MMOs), as is further discussed below.

Authentication can be performed by requesting the consumer enter a passcode into the agent's device, or by having a message sent to the consumer's device requesting the consumer enter the passcode. The consumer can also preauthorize the transaction before visiting the agent, which unlocks the consumer's account for a period of time. Consumer passcode authentication information can be maintained by the consumer's MMO, such as in a database which maps device identifiers to passcodes.

The requested transaction is then received by the mobile money platform (MMP) associated with the agent's MMO. At step 3, the agent's MMP can extract and capture transaction information from the request, such the consumer's device identifier, the agent's device identifier, the amount of the transaction, etc., and reformat the transaction information into a transaction request to be sent to a processing platform, such as Central Connection Processing Services 304 discussed above with respect to FIG. 3. The transaction request can be formatted, such as in a markup language, according to a standard published by the processing platform.

At step 4, the processing platform can use a registry, such as central registry 318 or a routing directory to lookup a PAN corresponding to the consumer's device identifier, and a PAN corresponding to the agent's device identifier. If no PAN is found for the consumer's device identifier, a one-time use PAN can be generated. The processing platform can then reformat the transaction information received from the agent's MMP and the PANs into a financial message to be sent to a payment processing network. In accordance with an embodiment, the processing platform can initiate an original credit transaction (OCT) using the PANs and transaction information, to transfer the appropriate funds from the consumer's account to the agent's account (for a cash-out transaction) or from the agent's account to the consumer's account (for a cash-in transaction). In embodiments of the invention, OCT messages can be used to debit and credit issuer accounts when, for example, funds are being transferred from a commercial account (e.g., an agent's account) to a different account (e.g., a prepaid account that will be used by the consumer). An OCT message is used to submit an original credit through a payment processor such as VisaNet to the recipient's issuer, and is explained in more detail in U.S. Pat. No. 8,016,185, which is herein incorporated by reference in its entirety for all purposes.

At step 5, the payment processor sends a transaction response to the processing platform with authorization and clearing details. At step 6, the processing platform can reformat the data in the transaction response, e.g., authorization and clearing details, into a response message and send the response message to the MMP. At step 7, the MMP can then create a notification, such as an SMS or similar message, and send the notification to the agent's device and the consumer's device confirming the transaction. The notification can be generated based on the information in the response message, such as by reformatting the information into a form which can be communicated to the agent and consumer devices. The MMP can also adjust account balance positions for both parties. If both parties are not associated with the same MMP, then the agent's MMP can send a message to the consumer's MMP, advising it of the transaction results. Alternatively, the processing platform can contact the consumer's MMP directly. At step 8, the agent can receive cash from the consumer (for a cash-in transaction) or dispense cash to the consumer (for a cash-out transaction). At step 9, the MMP can periodically send settlement reports to each mobile network operator (MNO) which include information about relevant transactions for each MNO. For example, in the example shown in FIG. 6, transaction details of the above-described transaction would be included in the settlement report sent to the consumer's MNO and the agent's MNO. At step 10 settlement occurs between each MNO, or an issuer bank associated with each MNO, via the payment processing network.

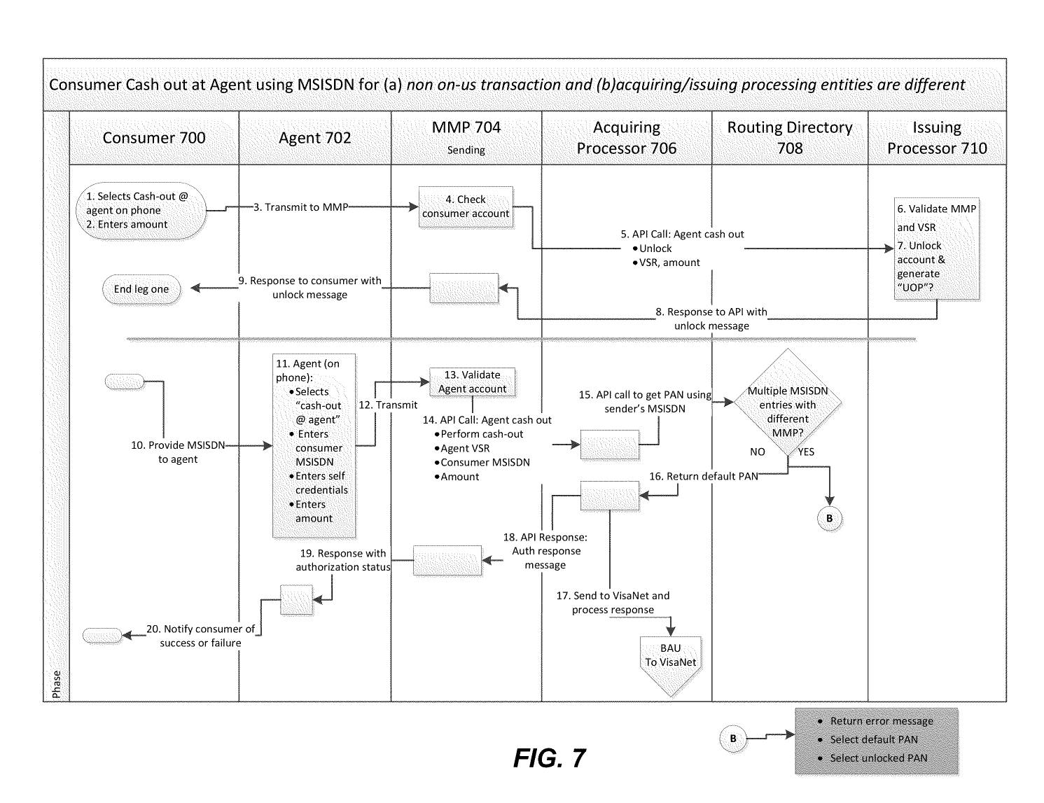

FIG. 7 shows a consumer-initiated cash-out transaction with an agent in an open loop system, in accordance with an embodiment of the invention. As shown in FIG. 7, a consumer 700 can initiate a cash-out transaction with an agent 702, request that their account be unlocked, and then visit the agent to complete the transaction and receive the requested cash. At step 1, the consumer 700 selects a “Cash-out @ Agent” option on his consumer device. In accordance with an embodiment, the consumer device can be a mobile phone. At step 2, the consumer enters an amount to withdraw on the consumer device. At step 3, the consumer sends the transaction request to his MMP 704. At step 4, the MMP 704 can check the consumer's account, e.g., check available funds, perform risk/fraud checks, etc. At step 5, the MMP 704 can format a request to unlock the consumer's account. The request can include the amount and a passcode or PIN provided by the consumer as authentication. The request can then be forwarded to an issuing processor 710 associated with the consumer's MMP. In accordance with an embodiment, the issuing processor can be the MMO/MNO which provides the MMP or an issuing bank associated with the MMO/MNO. At step 6, the issuing processor 710 can validate the information provided in the request. At step 7, the issuing processor can unlock the consumer's account and generate a UOP. At step 8, the issuing processor 710 returns an unlock message to the MMP 704. At step 9, the MMP formats and sends a notification to the consumer indicating whether the consumer's account has been successfully unlocked.

At step 10, the consumer 700 visits an agent 702 to complete the transaction, and provides the agent with their device identifier (e.g., a MSISDN associated with their mobile phone). At step 11, the agent, using the agent's device, can select the “Cash-out @ Agent” option and enter the consumer's device identifier, the agent's credentials (such as an agent's device identifier), and an amount. At step 12, the agent transmits the request to the agent's MMP 704. Although only a single MMP 704 is depicted in FIG. 7, in accordance with an embodiment, the consumer's MMP and the agent's MMP can be different MMPs. Similarly, the issuing and acquiring processors can be associated with the same or with different MNOs and/or financial institutions. At step 13, the agent's MMP validates the agent's account, for example by verifying a passcode provided by the agent through the agent's device. At step 14, the agent's MMP formats a transaction request which indicates that it is a cash-out request and includes an agent credential (agent VSR), the consumer device identifier, and an amount. This transaction request is sent to an acquiring processor 706 associated with the agent's MMP, such as a mobile gateway (i.e., CCP 204). At step 15, the acquiring processor formats and sends a request to a routing directory 708 to get a personal account number (PAN) corresponding to the consumer's device identifier.

At step 16, it is determined whether more than one PAN corresponds to the consumer's account identifier. If there is more than one PAN, then an error message can be returned and the transaction terminated. However, this is not ideal and provides a poor user experience. Alternatively, each PAN can have a lock parameter associated with it. If no PAN is found, a one-time use PAN can be generated. In step 7, described above, the consumer's account was unlocked. Therefore, if only one PAN associated with the consumer's device identifier is unlocked, then that PAN can be selected and processing can proceed to step 16. As described above, the lock parameter can be stored in the central registry 318 as part of the PAN to device identifier mapping. A further alternative enables the consumer to specify a default PAN which will be returned if multiple PANs are found.

At step 16, a PAN (e.g., the default PAN, the unlocked PAN, or the only PAN found) is returned from the routing directory 708 to the acquiring processor 706. At step 17, a financial request, including the transaction information and the PAN, is generated and sent to a payment processor, such as VisaNet, for processing. At step 18, an authorization response message is received by the acquiring processor 706 from the payment processing network. The acquiring processor extracts the information included in the authorization response and reformats the information to be sent to the agent's MMP, for example the authorization response from the payment processor can be reformatted into an XML message. At step 19, the MMP can extract the information included in the authorization response message and reformat the information into an authorization message sent to the agent, for example and SMS message. At step 20, the agent can inform the consumer as to the success or failure of the transaction. If successful, the agent can dispense the appropriate cash funds to the consumer and the transaction is complete.

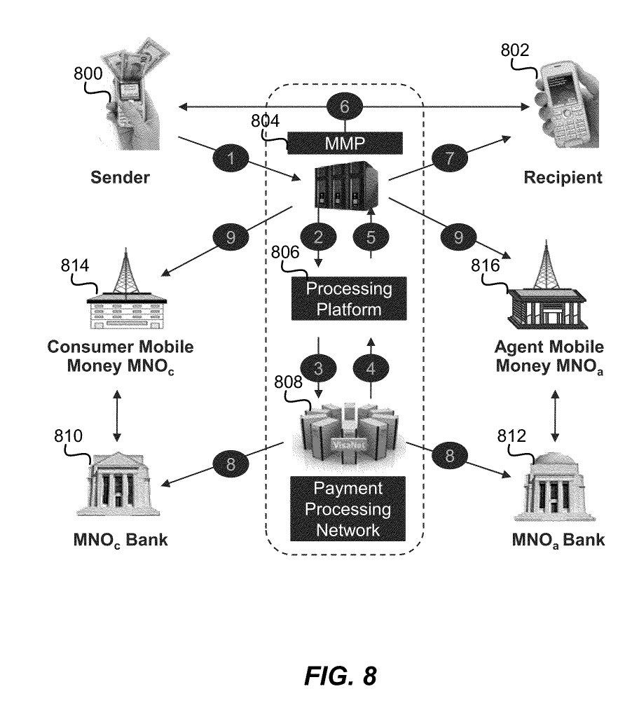

FIG. 8 shows a method of conducting a mobile to mobile P2P transfer in an open loop system, in accordance with an embodiment of the invention. At step 1, the payor consumer, using a payor consumer device 800, initiates a P2P transaction with their MMP 804 by providing transaction details to the MMP. These transaction details can be provided in an SMS message, or similar, and may include information such as the payor's passcode, an amount, and details of the payee consumer, such as an identifier associated with a payee device 802. At step 2, the MMP 804 debits the payor's account and formats a transaction request message, including transaction details, into a transaction request message and sends the transaction request message to processing platform 806, such as CCPS 304. The transaction request message can be formatted according to a standard published by the processing platform. At step 3, the processing platform can use a central repository 318 or routing directory to lookup the payee's PAN based on the details provided by the payor (e.g., the payee's phone number). The processing platform can then reformat the transaction details and the PANs and generate a financial request, such as an OCT, to be sent to a payment processor 808, such as VisaNet.

At step 4, the payment processor can send clearing details for the transaction in a response to the processing platform. At step 5, the payment processor can reformat the information included in the response into a transaction response message to be sent to the MMP 806. At step 6, the MMP can generate a confirmation message, such as an SMS message, to be sent to the payor and payee devices. The confirmation message can be based on the transaction response message, such as by reformatting all or a portion of the information in the transaction response message. The MMP can then send the confirmation to both the payor's device and the payee's device indicating whether the transfer has been successful.

At step 7, if the transfer was successful, the MMP can credit the payee's account. If both the payor and payee are not associated with the same MMP, then the payor's MMP can send a message to the payee's MMP, advising it of the transaction results. Alternatively, the processing platform can contact the payee's MMP directly. At step 8, the payment processor can complete settlement of the transaction with the sender's MNO 810 and the recipient's MNO 812. At step 9, the MMP can include information about this transaction in a periodic settlement report to the payor's and the payee's MMOs 814 and 816.

In accordance with an embodiment, bulk P2P transfers can also be performed. These bulk transfers are one-to-many transfers where a single payor account loads a plurality of payee accounts. Processing can proceed largely as above except payee details for multiple payees can be provided in a bulk format specified by the MMP.

In accordance with an embodiment, consumers without mobile money accounts can transfer funds to other consumers (both with and without mobile money accounts) through an agent. To initiate a transfer, a payor without a mobile money account can visit an agent and provide the agent with cash for the transfer. The agent can have a one-time PAN and a token generated for the payor. The payor can additionally set a passcode for the transfer. Once complete, the payor can provide the payee with the one-time PAN, token and passcode. The payee can then visit an agent, provide the one-time PAN, token and passcode and receive the cash transferred from the payor. Alternatively, if the payee has a mobile money account, the payor can provide a device identifier for the payee and the funds can be transferred from the one-time PAN to the payee's mobile money account.

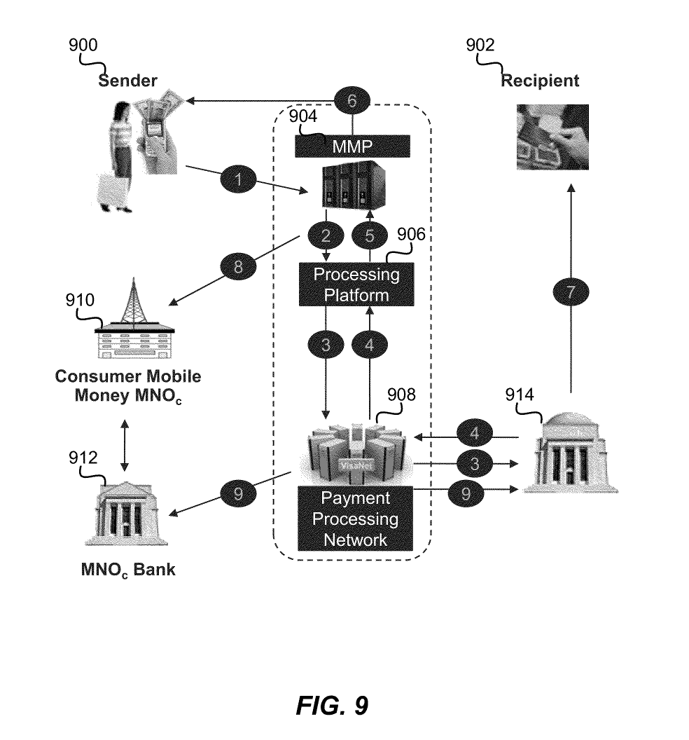

FIG. 9 shows method of conducting a mobile to card account P2P transfer in an open loop system, in accordance with an embodiment of the invention. In a similar P2P transaction to that described above with respect to FIG. 8, in FIG. 9 a payor 900 is transferring funds from their mobile money account, to a payee's card account 902, such as a debit, credit, or prepaid card account. At step 1, the payor consumer 900 can select a “send money” option on the payor's device and provide a passcode, amount to transfer, and payee details. The payee details can include an account number associated with the payee's card to which the funds are to be transferred, or an alias corresponding to the account number. Additionally, payee information can be stored and associated with the payor's account such that payee details do not have to be reentered every time a transfer is initiated. Instead, the payor can select the name of the payee from a list shown on the payor device, and the payee information can be retrieved and sent with the transaction request. The transaction request is then sent to the payor's MMP 904, and can be in the form of an SMS, email, or similar electronic communication.

At step 2, the MMP 904 authenticates the payor based on the provided passcode, and verifies that funds are available in the payor's account. The MMP can then debit the payor's account and reformat the transaction details into a second transaction request to be sent to the processing platform 906. The processing platform 906 can then reformat the information in the second transaction request into a financial message, such as an OCT, to be sent to payment processing network 908. At step 3, the processing platform sends the OCT to the payment processing network, which routes the OCT to a bank 914 associated with the payee's card account. At step 4, the bank 914 sends a confirmation message to the payment processor 908 which forwards the confirmation to the processing platform 906. At step 5, the processing platform reformats the information in the confirmation message and sends a notification to the MMP indicating whether the transfer was successful. At step 6, the MMP reformats the information in the notification and sends a message to the payor's device. The MMP can include additional information in the message to the payor device, such as the payor's new balance. At step 7, the bank 914 credits the payee's card account 902. At step 8, the MMP 906 reports the transaction to the payor's MMO 910, and at step 9, settlement occurs through the payment processor with the payor's MNO 912 and the bank 914. In accordance with an embodiment, transfers can also be effected from a card account to a mobile money account in a similar process to that described above.

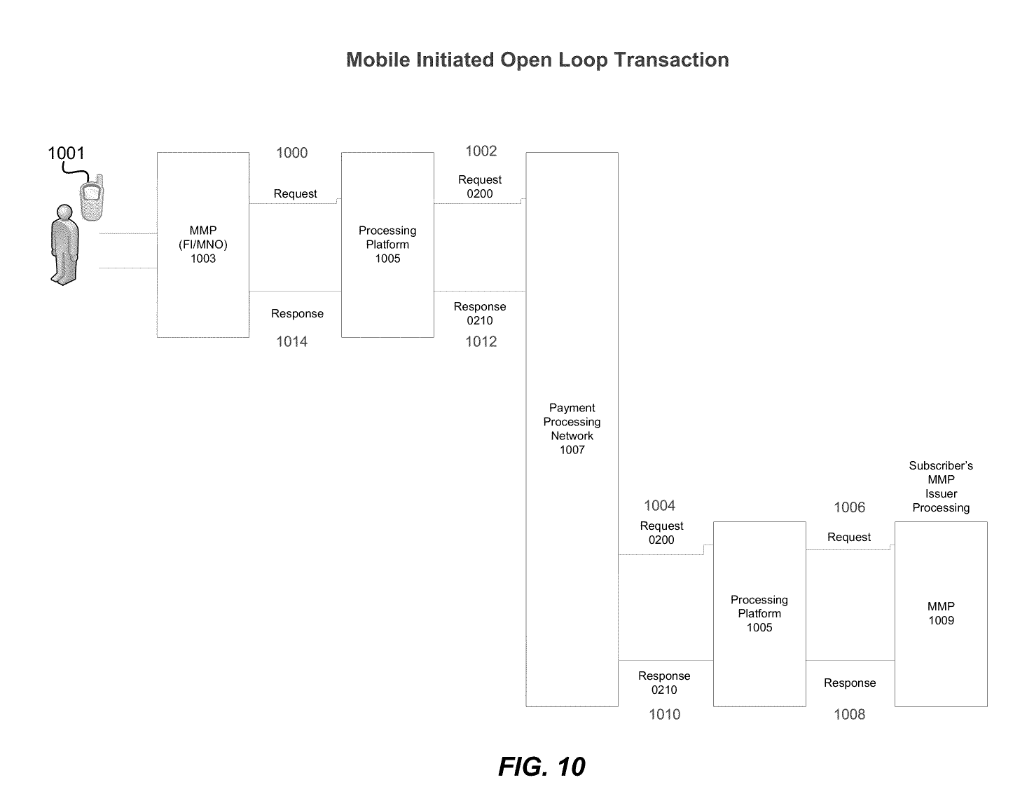

FIG. 10 shows a method of conducting a mobile initiated open loop transaction, in accordance with an embodiment of the invention. FIG. 10 shows a diagram of a mobile initiate open loop transaction, such as those described above. As shown in FIG. 10, a consumer can initiate a transaction using a consumer device 1001, such as a mobile phone, with an MMP 1003. Examples of mobile initiated open loop transactions include cash-in, cash-out, P2P and cash claim transactions. As described above, the request from the consumer can include a passcode used by the MMP to authenticate the consumer and transaction details, such as an amount and a recipient, depending on the type of transaction selecting.

At step 1000, after successfully authenticating the consumer, the MMP 1003 sends a transaction request to a processing platform 1005, such as CCPS 304. When the consumer initiates a transaction with the MMP, the consumer provides a plurality of transaction details in a message such as an SMS, email, or similar electronic communication. The MMP can extract and/or capture the transaction details, and reformat them into the transaction request which can be processed by the processing platform 1005. The processing platform is responsible for receiving transaction requests including transaction details from one or more MMPs and then formatting the request such that it can be processed by a payment processing network. At step 1002, the processing platform creates a financial message based on the transaction request received from the MMP and sends the financial message to a payment processing network. For example, with reference to the mobile management service of FIG. 3, a transaction processing and routing component 308 of CCPS 304 can receive, interpret and process the incoming request from the MMP, and create a 0200 financial message to be sent to payment processing network 1007, such as the VisaNet single message system (SMS), for processing.

The payment processing network 1007 can validate the financial message and confirm that it includes the appropriate transaction details for that transaction, such as a client ID associated with the MMP 1003, a platform ID, the consumer's device ID (e.g., a MSISDN), and a transaction type ID. The transaction type ID can be used to identify the transaction type, which can include cash-in, cash-out, P2P and cash claim transactions. The financial message can also include a transaction amount, a currency code (such as an ISO currency code), a transaction date, and a transaction time zone.

In accordance with an embodiment, each transaction type can include its own specific elements. For example, in a cash-in transaction, agent assisted domestic cash-in transactions can use an OFT message, and self-service transactions can use an AFT message. In a cash-in transaction, the initial message from the consumer's MMP to the CCPS can include the consumer's device ID, amount, the agent's device ID. The message can also include the consumer MMP's client ID, a description of the agent and his location, and the agent's ID with the MMP. A second message, from the CCPS to the agent's MMP, can further include the cash-in transaction ID and the consumer's account ID.

In accordance with an embodiment, in a cash-out transaction, a “Manual Cash” message can be used. An unlock message from the consumer MMP to the CCPS can include a max amount, the consumer MMP ID and a consumer account ID. A second message from the CCPS to the consumer MMP can include a use-once PAN. A third message, from the agent's MMP to the CCPS can include the use-once PAN, an agent ID, the agent's MMP ID, and the amount. A fourth message, from the CCPS to the consumer MMP, can include the cash-out transaction type, the agent's MMP ID, a consumer account ID, the amount, the agent's ID and a description of the agent and/or the agent's location.

In a P2P transaction, an initial message, from the payor's MMP to the CCPS can include the payee's device identifier or a static PAN, a transaction type (P2P), and an amount. The initial message can also include payor's AID, the payor's MMP ID, and the payor's device identifier. Optionally, the initial message can also include the payor's name. A second message, from the CCPS to the payee's MMP can include the payee's AID, the P2P transaction type, the amount, the payor's AID, the payor's MMP ID, and the payor's device identifier. This message can also optionally include the payor's name. In the case of cross-border P2P transactions, an address for the payee and/or payor may be required to be included in the initial and/or second message.

Prior to step 1002, the processing platform 1005 can validate the incoming data elements for each initial message, as listed above. For example, the CCPS can check that the transaction type sent in by the MMP 1003 is valid and that it can be converted into an appropriate processing code (e.g.—26 first two positions for P2P) for the next leg of processing to the payment processing network.

As described above, at step 1002, the processing platform can prepare and format the incoming request from the MMP 1003 into a 0200 financial request to the payment processor. In accordance with an embodiment, the processing platform can derive the following data elements to prepare the 0200 full financial message to send to the payment processor for Cash In, Cash Out, P2P and Cash Claim transactions. These data elements can include:
Message identification parameters (Processing code, Business Application Indicator, MCC)
Lookup PAN from Central Registry based on the consumer's device identifier. (If the PAN is provided in the initial message, the CCPS can directly pass the request to the payment processing network.
Payment Processing Network ID (which can be determined based on the BIN)
Acquirer Information (e.g., Acquirer BIN, Acquirer Institution ID, Acquirer Country code etc.)
Amount (funds sent to recipient in local currency)
Currency code
Authorization Responses and reason codes, if any

In accordance with an embodiment, some transaction-specific variations can be provided for. For example, in an agent-assisted open-loop cash-in transaction, the processing platform can look up the PAN for the consumer in the central registry based on the consumer's device identifier and initiates an OCT from the consumer's PAN. In an agent-assisted cash-out transaction, the transaction initiated by the processing platform can be a manual cash transaction. In a P2P transaction, the processing platform can look up the payee's PAN in the central registry (based on the payee's device identifier) and initiate an OCT transaction using the payee's PAN. Additionally, the processing code for each OCT transaction can be captured.

At step 1004, the processing platform 1005 can receive and translate the 0200 financial request from the payment processing network for cash-in, cash-out, P2P and cash claim transactions. The processing platform can receive, interpret and process the 0200 financial message. At step 1006, the processing platform can prepare, format and route the authorization request to the subscriber's MMP based on the 0200 financial request received from the payment processing network. In accordance with an embodiment, the authorization component of the inbound 0200 is passed to the issuing MMP 1009 to perform the authorization. The processing platform 1005 can identify the issuing MMP 1009 based on the PAN where funds are to be withdrawn. In accordance with an embodiment, the processing platform can have a standard format for sending authorization requests to an MMP and for receiving the response back from an MMP. Elements included in a standard authorization request can include a Mobile Money Platform ID, the consumer's mobile money ID, a currency code, a transaction amount, a device identifier, if available, the transaction type, and a transaction ID. This information can be stored per the payment processing network's data retention policy.

At step 1008, the processing platform 1005 can receive and translate the financial authorization response message from the MMP 1007 for cash-in, cash-out, P2P and cash claim transactions. In accordance with an embodiment, the processing platform can provide a standard response message for the MMP to use to reply to an authorization request, the processing platform can then receive and interpret the response. The processing platform can log the response from the MMP 1009 using a transaction ID and perform any necessary translations to generate a 0210 response message to send to the payment processing network. The authorization response and declines codes in the case of a decline can also be logged and sent to the payment processing network. At step 1010, the processing platform can format and translate the financial response message into a 0210 financial response to the payment processing network. The processing platform can generate the 0210 financial response message based on the processing results and responses from the MMP 1009. At step 1012, the payment processing network 1007 can process the 210 financial response and can send the 210 financial response message along with clearing details to the consumer's MMP 1003 through the processing platform. The processing platform can receive and translate the 0210 financial response message from the payment processing network for cash-in, cash-out, P2P and cash claim transactions. The processing platform 1005 can capture the clearing details it receives from the payment processing network and can include the clearing details in the outbound response to the consumer's MMP 1003.

At step 1014, the processing platform can format and send a transaction complete confirmation to processing platform consumer's MMP 1003. When the 0210 financial response is received at processing platform as the processing endpoint, the confirmation of transaction completion can be sent to the consumer's MMP 1003.

The response sent to the consumer's MMP 1003 can include the following transactional data elements:
MMP ID (the identifier of the platform providing the technology/operations for the mobile money service)
Consumer's mobile money ID (consumer's mobile money account identifier)
Currency Code
Amount
Transaction Type (Indicator of the type of transaction, e.g.—Cash-out, Money transfer, ATM withdrawal etc.)
Consumer's device identifier
Transaction ID assigned by the payment processing network
Final Status of transaction (e.g. Transaction Successfully Complete, Transaction Declined with decline code, transaction failure with failure code, etc.)

Subsequently, the consumer's MMP can extract and reformat information included in the transaction complete confirmation received from the processing platform, and generate a confirmation message to be returned to the consumer 1001. The confirmation message can be an SMS, email, or other suitable electronic communication. The confirmation can include all or a portion of the information included in the transaction complete confirmation after it has been extracted and reformatted by the consumer's MMP 1003.

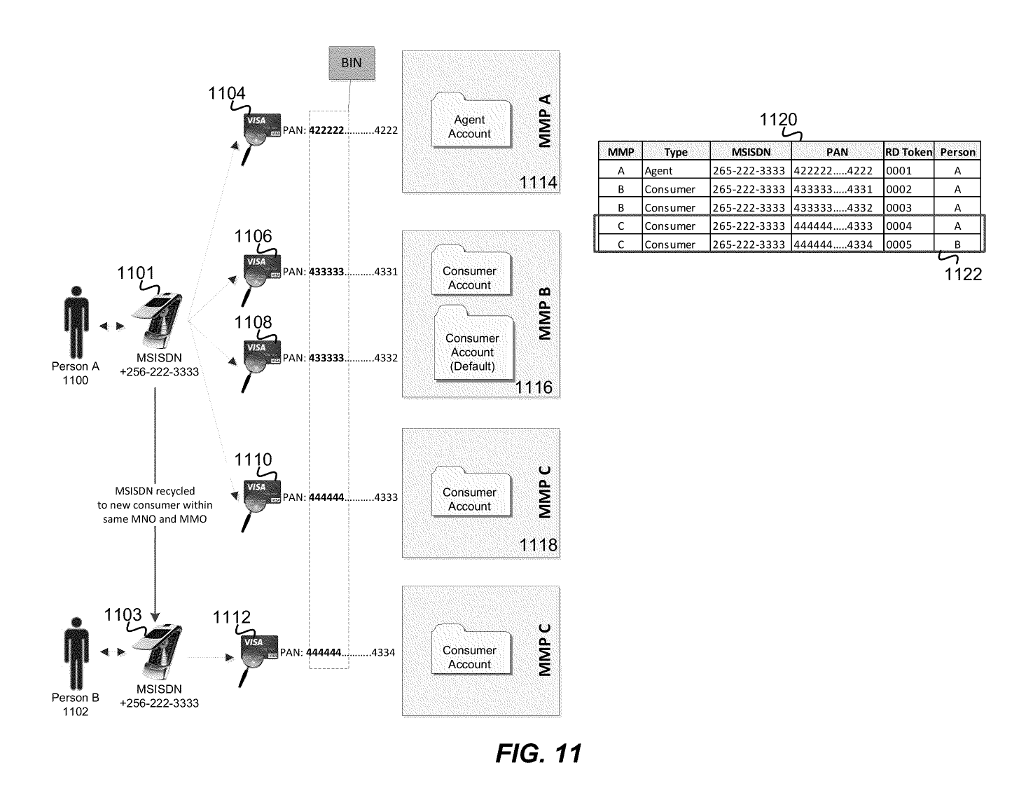

FIG. 11 shows an example of device identifier recycling errors, in accordance with an embodiment of the invention. Device identifiers may be recycled by a service provider when the consumer stops using the device identifier, closes an account with the service provider, or requests a new device identifier. For example, in the case of mobile phone numbers as device identifiers, if the consumer moves out of the area or requests a new phone number, that consumer's old phone number will likely be recycled and issued to a new consumer. This presents the potential of unintentional transfers to the wrong party.

As shown in FIG. 11, person A 1100 can have a plurality of accounts (1104-1110) associated with their device identifier associated with their device 1101. These accounts can each be associated with the same or different service providers. For example, account 1104 can be an agent account associated with MMP A 1114, while accounts 1106 and 1108 can each be consumer accounts associated with MMP B 1116. Account 1110 can be another consumer account associated with a third MMP C 1118. This could be a new account created with MMP C, in addition to accounts 1104-1108 which remain valid, or it could be a result of person A porting their number to a new MMP. Upon porting, the old numbers should be made invalid, but it is possible for their mapping to still exist in the routing directory 1120. Subsequently, if person A 1100 no longer uses their device identifier, it can be recycled to person B 1102 and associated with their device 1103. When person B registers an account 1112 with MMP C, person A's old account should no longer be valid, but could still be listed in the routing directory. As shown at 1122, this presents the possibility that funds intended for either person A or person B could be mistakenly directed to the wrong party.

In accordance with an embodiment, to address this recycling issue, if more than one PAN is found associated with the device identifier, then an error code can be returned indicating that multiple accounts have been found associated with that device identifier. The error code can be returned to the consumer via the processing platform and MMP and can advise the consumer to obtain a static VPAN from the recipient to complete the transaction. Alternatively, a default PAN can be selected from among the plurality of PANs associated with the device identifier. In accordance with an embodiment, the default PAN can be setup prior to the transaction by the recipient. If a default PAN is present, then processing can continue. For example, the default PAN could be the account which was created most recently. Whether the system selects a default PAN or returns an error message can be configured by each MMP based on each MMPs assessment of risk for a given transaction or for a given consumer.

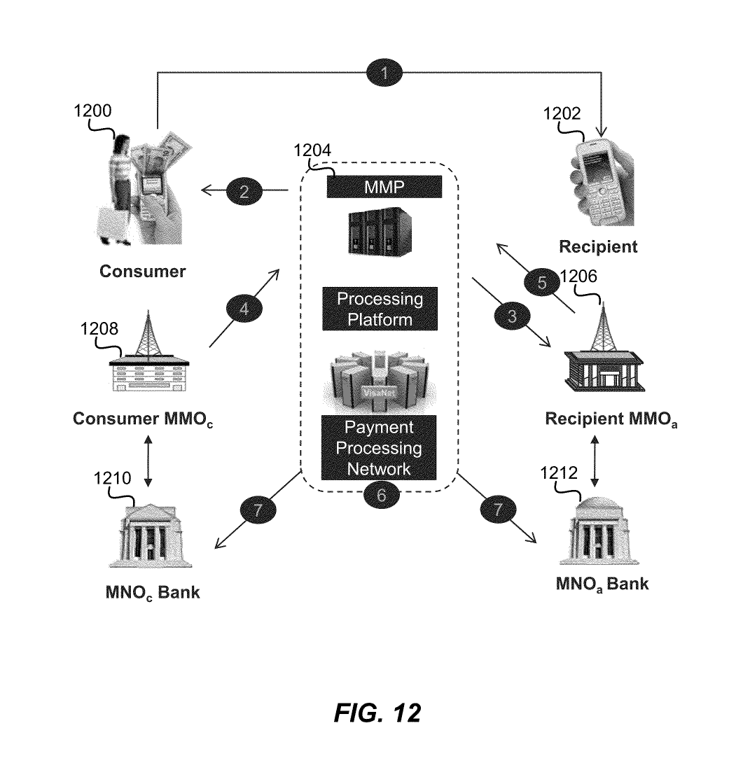

FIG. 12 shows a method of reconciliation and settlement, in accordance with an embodiment of the invention. As shown in FIG. 12, at step 1 the consumer 1200 performs a transaction, for example a P2P transfer from the consumer to a recipient 1202. At step 2, the MMP 1204 can debit the consumer's account and credit a control account held by the MMP. The MMP 1204 can also notify the recipient's service provider 1206 (e.g., their mobile money operator) of the transaction details. Additionally, the MMP can create a settlement ledger entry for the transaction. At step 4, the MMP can extract entries from the consumer's MMO 1208 for the recipient's MMO. At step 5, the MMP extracts entries from the recipient's MMO 1206. At step 6, the MMP 1204 reconciles the extracts from each MMO and calculates a settlement amount. At step 7, the MMP debits the consumer account at the consumer's MNO 1210 and credits the recipient account at the recipient's MNO 1212.

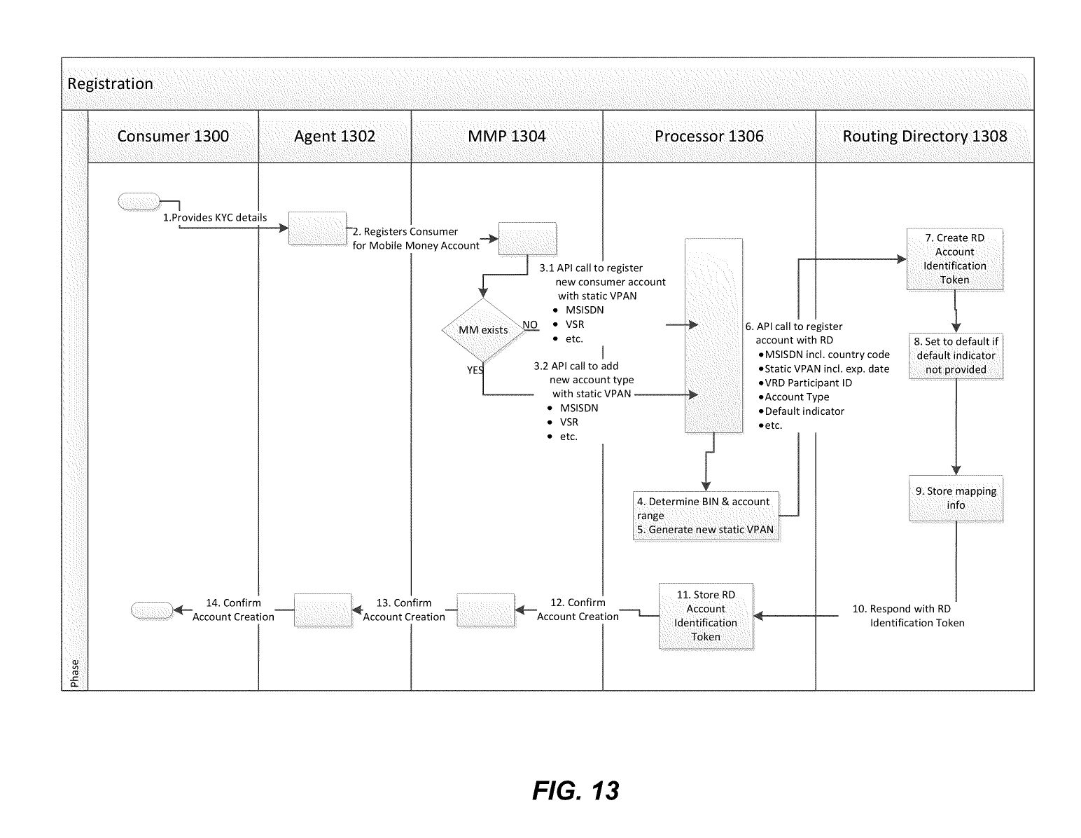

FIG. 13 shows a method of consumer registration, in accordance with an embodiment of the invention. As shown in FIG. 13, a consumer 1300 can create an account with the mobile money platform 1304 by visiting an agent 1302. At step 1, the consumer 1300 can visit the agent 1302 and provide “Know Your Customer” (KYC) details. This can include basic identity information about the consumer as well as more detailed consumer behavior and transaction patterns, and other consumer due diligence information. At step 2, the agent 1302 can register the consumer for a mobile money account with the mobile money platform (MMP) 1304. The MMP 1304 can run a check to determine whether the consumer already has a mobile money account. If no, at step 3.1 the MMP 1304 can send a call to the processing platform 1306 to register a new consumer account with a static VPAN. The call can include the consumer's device identifier, a consumer ID or similar credential (VSR), etc. If the consumer already has a mobile money account, then at step 3.2 the MMP 1304 can send a call to the processing platform 1306 to create a new account type associated with the consumer with a new VPAN. This call can also include the consumer's device identifier, a consumer ID or similar credential (VSR), etc.

At step 4, the processing platform 1306 can determine a BIN and account range for the new VPAN. At step 5, the processing platform 1306 can generate the new static VPAN. At step 6, the processing network can send a request to register the new VPAN with the routing directory. The request can include the consumer's device identifier, the newly generated static VPAN and expiration date, the consumer's service provider (participant ID), the account type, and optionally a default indicator. At step 7, the routing directory 1308 can create an account identification token. At step 8, if no default indicator is included, then a default account can be automatically selected by the routing directory. In accordance with an embodiment, the routing directory 1308 can select the most recent account added as the default account. Alternatively, the routing directory 1308 can select the first account added as the default account. At step 9, the routing directory 1308 can store mapping information between the newly added VPAN and the consumer's device identifier so that the VPAN can be looked-up using the consumer's device identifier. At step 10, the routing directory 1308 can send the identification token to the processing platform 1306 which, at step 11, can store the token. At step 12, the processing platform 1306 can confirm account creation to the MMP 1304, which can then confirm account creation to the agent 1302 (step 13), who can then confirm that the account has been created to the consumer 1300 (step 14).

As described above, each MMO can request non-personalized payment cards to be used by consumers in combination with some mobile transactions. These payment cards can be requested in bulk through the CCPS 304. When a bulk order is received, the CCPS can identify a range of PANs associated with the MMO's BIN and forward the order to a card vendor to generate the payment cards and fulfill the bulk order. Once the payment cards have been created they can be delivered directly to the MMO's agents for distribution to consumers or, alternatively, they can be delivered to the MMO which can then distribute the cards to its agents for distribution to consumers.

Additionally, consumers can purchase additional airtime for their mobile device through CCPS 304. The consumer can initiate a buy airtime function on their device, provide their passcode and select an amount of airtime to purchase. CCPS 304 can validate and authenticate the request and debit the consumer's account for the airtime purchase. CCPS 304 can then credit the consumer's MMO for the airtime purchase and send a confirmation to the consumer. The MMO can credit the consumer with the purchased airtime.

CCPS 304 can also respond to transaction inquiries from consumers. The consumer's MMO can receive a transaction inquiry from the consumer. The MMO can request a passcode from the consumer to authenticate the consumer's identity. Once authenticated, the MMO can request reference parameters from the consumer, e.g. a period of time or a reference to a particular statement. The MMO can then send a request to the CCPS 304 to retrieve account information for the consumer based on the reference parameters. For example, if the consumer requests a particular month's statement, that month's statement can be retrieved and sent to the consumer via their MMO. Alternatively, if the consumer requests a list of transactions over an arbitrary period of time, the CCPS can look up transactions over that period of time and send a listing of them to the consumer via their MMO.

Embodiments of the invention have a number of advantages. As noted above, a payment processing network that is configured to process debit and credit payment card transactions can be used to facilitate payments between multiple mobile devices, while allowing mobile network operators to act like traditional payment card issuers. The accounts for transferors and transferees of payments can be held by MNOs, and these MNOs can manage their accounts. As a result, consumers can conduct a variety of transactions, such as pay for purchases, make transfers to friends and relatives, and make deposits and withdrawals, using ordinary mobile phones, while leveraging the benefits of traditional payment processing networks. Such benefits may include enhanced fraud detection as well as assurance that the transactions are being conducted securely and without failure. As noted above, in some embodiments of the invention, conventional payment card type PANs (primary account numbers) can be used as a way to provide communication between various MNOs. These PANs need not be disclosed to the end users as in conventional payment processes. Rather, end users only need to know the mobile device identifiers to conduct payment transactions.

With reference to FIG. 14, an exemplary server computer 1400 is shown. The exemplary server computer 1400 is illustrated as comprising a plurality of hardware and software modules (1401-1412). However, it should be appreciated that this is provided for illustration purposes only, and each of the modules and associated functionality may be provided and/or performed by the same or different components. That is, exemplary server computer 1400 may, for example, perform some of the relevant functions and steps described herein with reference to the MMP, CCP, and payment processing network through the use of any suitable combination of software instructions and/or hardware configurations. It should be noted that although FIG. 14 illustrates modules located on a single device, the disclosure is not meant to be so limited, the modules and associated functionality represented thereby can be distributed across a plurality of server computers which may be separately associated with the MMP, CCP and payment processing network. Moreover, a system for implementing the functionality described herein may have additional components or less then all of these components. Additionally, some modules may be located on other devices such as a remote server or other local devices that are functionally connected to the server computer component(s).

The exemplary server 1400 is shown as comprising a processor 1401, system memory 1402 (which may comprise any combination of volatile and/or non-volatile memory such as, for example, buffer memory, RAM, DRAM, ROM, flash, or any other suitable memory device), and an external communication interface 203. Moreover, one or more of the modules 1404-1412 may be disposed within one or more of the components of the system memory 1402, or may be disposed externally. As was noted above, the software and hardware modules shown in FIG. 14 are provided for illustration purposes only, and the configurations are not intended to be limiting. For example, a server computer can include one or more of the modules corresponding to those described above with respect to FIG. 3. The processor 1401, system memory 1402 and/or external communication interface 1403 may be used in conjunction with any of the modules described below to provide a desired functionality. Some exemplary modules and related functionality may be as follows:

The communication module 1404 may be configured or programmed to receive and generate electronic messages. When an electronic message is received by the server computer 1400 via external communication interface 203, it may be passed to the communications module 204. The communications module 1404 may identify and parse the relevant data based on a particular messaging protocol. The received information may comprise, for instance, identification information, transaction information, and/or any other information may be utilized in a financial transaction. The communication module 1404 may then transmit any received information to an appropriate module within the server computer 1400 (e.g. via a system bus line). The communication module 1404 may also receive information from one or more of the modules in server computer 1400 and generate an electronic message in an appropriate data format in conformance with a transmission protocol so that the message may be sent to one or more components within a system (e.g. to an issuer computer or merchant computer). The electronic message may then be passed to the external communication interface 1403 for transmission. The electronic message may, for example, comprise an authorization response message (e.g. to be transmitted to a merchant conducting a transaction) or may be an authorization request message to be transmitted or forwarded to an issuer.

The database look-up module 1405 may be programmed or configured to perform some or all of the functionality associated with retrieving information from one or more databases 1413. In this regard, the database look-up module 1405 may receive requests from one or more of the modules of server 1400 (such as communication module 1404, authorization module 1408, or settlement module 1409) for information that may be stored in one or more of the databases 1413. The database look-up module 1405 may then determine and query an appropriate database. The database update module 1406 may be programmed or configured to maintain and update the databases 1413, such as authorization database 1414, user accounts database 1415, device identifier database 1416 and mobile network operator database 1417. In this regard, the database update module 1406 may receive information about a user, financial institution, a payment device, and/or current or past transaction information from one of the modules discussed herein. This information may then be stored in the appropriate location in the database 1413 using any suitable storage process.

The report generation module 1407 may be programmed or configured to perform some or all of the functionality associated with generating a report regarding a consumer, an account, a transaction or transactions, or any other entity or category of information. This may include, for instance, identifying patterns (such as patterns that indicate a fraudulent transaction or transactions) and generating one or more alerts that may be sent (e.g. via communication module 1404 and external communication interface 1403) to one or more entities, including the consumer, agent, or MNO. The report generation module may also, for example, request information from one or more of the databases 1413 via database look-up module 1405.

The authorization module 1408 may be configured or programmed to perform some or all the functionality associated with authorizing a financial transaction associated with an authorization request message. The authorization module 1408 may, for instance, be programmed or configured to compare the information received by via the authorization request message with stored information at the server 1400 or a database 1413 (such as comprising verification values). In some embodiments, if the received and stored values match, the authorization module 1408 may authorize the transaction (or may be more likely to authorize the transaction) and may instruct the communication module 1401 to generate an authorization response message. The authorization module 1407 may also be programmed or configured to execute any further operations associated with a typical authorization.

The server computer may have access to one or more databases 210, such as authorization database 1414. Each of the databases shown in this example may comprise more than one database, and may be located in the same location or at different locations. The authorization database 1414 may contain information related to a payment device and/or a payment account, as well as any other suitable information (such as transaction information) associated with the payment account.

Provided below are descriptions of some devices (and components of those devices) that may be used in the systems and methods described above. These devices may be used, for instance, to receive, transmit, process, and/or store data related to any of the functionality described above. As would be appreciated by one of ordinary skill in the art, the devices described below may have only some of the components described below, or may have additional components.

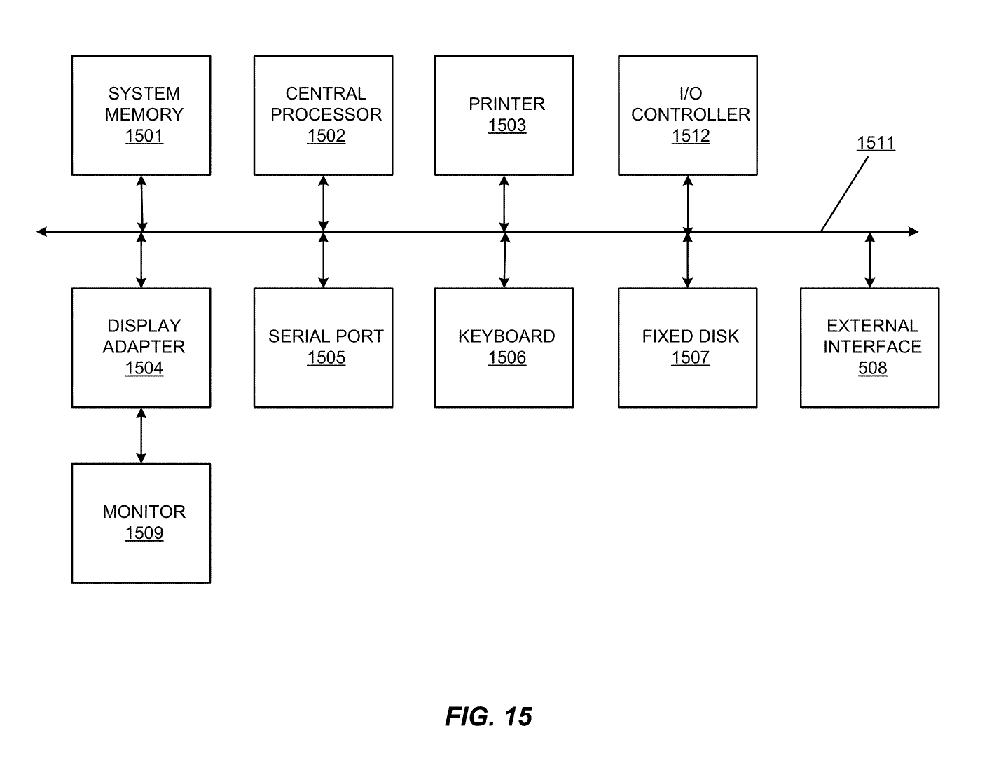

FIG. 15 illustrates exemplary elements of a computer apparatus. As noted above, the various participants and elements described can operate one or more computer apparatuses to facilitate the functions described herein. As would be appreciated by one of skill in the art after reading this disclosure, any of the elements described above can use any suitable number of systems and subsystems to facilitate the functions described herein. Moreover, each of the systems and subsystems may comprise any number of hardware and software modules, such as those described above.

Examples of such systems, subsystems, and components are shown in FIG. 15. The subsystems and components shown in FIG. 15 are interconnected via a system bus 1511. Additional subsystems such as a printer 1503, keyboard 1506, fixed disk 1507 (or other memory comprising computer readable media), monitor 1509, which is coupled to display adapter 1504, and others are shown. Peripherals and input/output (I/O) devices, which coupled to I/O controller 1512, can be connected to the computer system by any number of means known in the art, such as serial port 1505. For example, serial port 1505 or external interface 1508 can be used to connect the computer apparatus to a wide area network such as the Internet, a mouse input device, or a scanner. The interconnection via system bus allows the central processor 1502 to communicate with each subsystem and to control the execution of instructions from system memory 1501 or the fixed disk 1507, as well as the exchange of information between subsystems. The system memory 1501 and/or the fixed disk 1507 can embody a computer readable medium.

With reference to FIG. 16, a block diagram of an exemplary mobile device 36 is shown that may be used in some embodiments. In some embodiments, the mobile device 36 may be a notification device that can receive alert messages, a payment device that can be used to make payments, an access device (e.g. POS device) that may receive information from a consumer to conduct a transaction, and/or a multi-purpose general use device. The exemplary mobile device 36 shown in FIG. 16 may comprise a computer readable medium 36(b) that be present within the body (or outer casing) 36(h), or the computer readable medium 36(b) could be detachable from the device (e.g. the computer readable medium 36(b) could comprise an external memory that could be connected through a physical interface such as a USB connection, or the data could be hosted remotely and accessed wirelessly by the device—e.g. the data could be hosted and stored at a remoter server in the “cloud”). The computer readable medium 36(b) may be in the form of a memory that stores data. The memory may store information such as financial information, transit information (e.g., as in a subway or train pass), access information (e.g., access badges), serial numbers, mobile account information, and any other suitable information. In general, any of this information may be transmitted by the mobile device 36 (such as to an access device 34), via any suitable method, including the use of antenna 36(a) or contactless element 36(g). The body 36(h) may be in the form a plastic substrate, housing, or other structure.

In some embodiments, the mobile device 36 may further include a contactless element 36(g), which is typically implemented in the form of a semiconductor chip (or other data storage element) with an associated wireless transfer (e.g., data transmission) element, such as an antenna. Contactless element 36(g) may be coupled to (e.g., embedded within) the mobile device 36 and data or control instructions that are transmitted via a cellular network may be applied to the contactless element 36(g) by means of a contactless element interface (not shown). The contactless element interface functions to permit the exchange of data and/or control instructions between the mobile device circuitry and an optional contactless element 36(g), or between another device having a contactless element (e.g. a POS terminal or a payment device). Contactless element 36(g) may be capable of transferring and receiving data using a short range wireless communication capability. As noted above, mobile device 36 may comprise components to both be the interrogator device (e.g. receiving data) and the interrogated device (e.g. sending data). Thus, the mobile device 36 may be capable of communicating and transferring data or control instructions via both cellular network (or any other suitable wireless network—e.g. the Internet or other data network) and short range communications.

The mobile device 36 may also include a processor 36(c) (e.g., a microprocessor) for processing the functions of the phone 36 and a display 36(d) to allow a consumer to see phone numbers and other information and messages. The mobile device 36 may further include input elements 36(e) to allow a user to input information into the device, a speaker 36(f) to allow the user to hear voice communication, music, etc., and a microphone 36(i) to allow the user to transmit her voice through the mobile device 36. The mobile device 36 may also include an antenna 36(a) for wireless data transfer (e.g., data transmission).

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided herein within the specification or within the figures are by way of example only.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

What is claimed is:

1. A method comprising:
receiving a transaction request to transfer funds from a payor to a payee, wherein the transaction request includes a plurality of transaction details including a payor device identifier, a payee device identifier and an amount;
determining a payor account identifier associated with the payor device identifier, and a payee account identifier associated with the payee device identifier;
determining a first service provider associated with the payor device based on the payor device identifier, and a second service provider associated with the payee device based on the payee device identifier; and
initiating the transfer of funds from the first service provider to the second service provider using the payor account identifier and the payee account identifier;
wherein at least one of the first and second service providers is a mobile network operator.

2. The method of claim 1, further comprising:
sending a notification to the payor device and a notification to the payee device that the transfer is complete.

3. The method of claim 1, wherein the first service provider is a first mobile network operator associated with the payor device, and the second service provider is a second mobile network operator associated with the payee device.

4. The method of claim 1, further comprising:
generating a one-time use payor account identifier when a payor account identifier associated with the payor device identifier cannot be determined, wherein the one-time use payor account identifier is generated based on the payor device identifier; and
transferring the funds from the first service provider to the second service provider using the one-time use payor account identifier and the payee account identifier.

5. The method of claim 1, further comprising:
generating a one-time use payee account identifier when a payee account identifier associated with the payee device identifier cannot be determined, wherein the one-time use payee account identifier is generated based on the payee device identifier, and
transferring the funds from the first service provider to the second service provider using the payor account identifier and the one-time use payee account identifier.

6. The method of claim 1, wherein the payor and payee account identifiers are determined using a directory which maps device identifiers to account identifiers.

7. The method of claim 6, further comprising:
if a plurality of account identifiers are associated with the payor device identifier, then
determining a lock status associated with each of the plurality of account identifiers, and
identifying as the payor account identifier, an account identifier in the plurality of account identifiers which has a lock status of unlocked.

8. The method of claim 1, wherein initiating the transfer of funds from the first service provider to the second service provider using the payor account identifier and the payee account identifier, comprises:
reformatting the transaction request from a first format to create a second transaction request having a second format, wherein the second transaction message includes the plurality of transaction details and the payor and payee account identifiers; and
sending the second transaction request to a processing platform to initiate the transfer of funds.

9. The method of claim 8, wherein the first format is an SMS message format and the second format is an XML message format.

10. The method of claim 1, wherein the first service provider is a first mobile network operator associated with the payor device, and the second service provider is a second mobile network operator associated with the payee device.

11. A system comprising:
a computer, including a computer readable medium and processor, wherein the computer readable medium includes code stored thereon which, when executed by the processor, cause the processor to implement the method of
receiving a transaction request to transfer funds from a payor to a payee, wherein the transaction request includes a plurality of transaction details including a payor device identifier, a payee device identifier and an amount;
determining a payor account identifier associated with the payor device identifier, and a payee account identifier associated with the payee device identifier;
determining a first service provider associated with the payor device based on the payor device identifier, and a second service provider associated with the payee device based on the payee device identifier; and
initiating the transfer of funds from the first service provider to the second service provider using the payor account identifier and the payee account identifier;
wherein at least one of the first and second service providers is a mobile network operator.

12. The system of claim 10, wherein the computer readable medium further includes code which when executed by the processor causes the processor to implement the step of:
sending a notification to the payor device and a notification to the payee device that the transfer is complete.

13. The system of claim 10, wherein the first service provider is a first mobile network operator associated with the payor device, and the second service provider is a second mobile network operator associated with the payee device.

14. The system of claim 10, wherein the computer readable medium further includes code which when executed by the processor causes the processor to implement the steps of:
generating a temporary payor account identifier when a payor account identifier associated with the payor device identifier cannot be determined, wherein the temporary payor account identifier is generated based on the payor device identifier; and
transferring the funds from the first service provider to the second service provider using the temporary payor account identifier and the payee account identifier.

15. The system of claim 10, wherein the computer readable medium further includes code which when executed by the processor causes the processor to implement the steps of:
generating a temporary payee account identifier when a payee account identifier associated with the payee device identifier cannot be determined, wherein the temporary payee account identifier is generated based on the payee device identifier, and
transferring the funds from the first service provider to the second service provider using the payor account identifier and the temporary payee account identifier.

16. The system of claim 10, further comprising:
a routing which maps device identifiers to account identifiers, wherein the payor and payee account identifiers are determined using the routing directory.

17. The system of claim 16, wherein the computer readable medium further includes code which when executed by the processor causes the processor to implement the steps of:
if a plurality of account identifiers are associated with the payor device identifier, then
determining a lock status associated with each of the plurality of account identifiers, and
identifying as the payor account identifier, an account identifier in the plurality of account identifiers which has a lock status of unlocked.

18. The system of claim 16, wherein the computer readable medium further includes code which when executed by the processor causes the processor to implement the steps of:
if a plurality of account identifiers are associated with the payee device identifier, then rejecting the transaction request and returning and error message to the payor.

19. The system of claim 10, wherein the computer readable medium further includes code which when executed by the processor causes the processor to implement the steps of:
reformatting the transaction request from a first format to create a second transaction request having a second format, wherein the second transaction message includes the plurality of transaction details and the payor and payee account identifiers; and
sending the second transaction request to a processing platform to initiate the transfer of funds.

20. The system of claim 19, wherein the first format is an SMS message format and the second format is an XML message format.

21. A method, comprising:
receiving, by an agent, a request from a consumer to perform a cash-out transaction, wherein the request can include a device identifier, an amount and a passcode;
authenticating the consumer based on the passcode;
sending a request to a mobile money platform (MMP) to initiate the cash-out transaction, wherein the MMP can determine a mobile network operator associated with the consumer; and
wherein the MMP can reformat the request into a second request, and send the second request to a processing platform which can
look-up an account identifier associated with the device identifier, and
transfer funds corresponding to the amount from an account associated with the consumer to an account associated with the agent.

22. The method of claim 21, further comprising:
disbursing, from the agent to the consumer, cash funds corresponding to the amount.

23. The method of claim 21, wherein to transfer the funds corresponding to the amount, the processing platform can format and send an original credit transaction (OCT) message to a payment processor.

24. The method of claim 21, further comprising:
wherein the MMP can send a settlement report to a mobile network operator (MNO) associated with the consumer and an MNO associated with the agent including settlement details for the cash-out transaction.
